(19) United States
(12) Patent Application Publication
(10) Pub. No.: US 2002/0155934 A1
(43) Pub. Date: Oct. 24, 2002

(54) Composite roll of cemented carbide, and steel hot-rolling method using the same

(76) Inventors: Hideo Kijima, Chiba (JP); Toshiki Hiruta, Chiba (JP); Kazuhito Kenmochi, Chiba (JP); Toshiyuki Hattori, Fukuoka (JP); Maki Horiuchi, Fukuoka (JP)

Correspondence Address: Schnader Harrison Segal & Lewis, IP Department, 36th Floor, 1600 Market Street, Philadelphia, PA, 19103, US

(21) Appl. No.: 10/019,899

(22) PCT Filed: May 15, 2001
(86) PCT No.: PCT/JP01/04043

(30) Foreign Application Priority Data
May 16, 2000 (JP) 2000-142914
May 16, 2000 (JP) 2000-142915
Feb. 5, 2001 (JP) 2001-028788
Feb. 5, 2001 (JP) 2001-028789
Feb. 5, 2001 (JP) 2001-028790
Feb. 5, 2001 (JP) 2001-028791

(51) Int. Cl. B25F 5/02; F16C 13/00

(52) U.S. Cl. 492/58; 492/54; 492/40

(57) ABSTRACT

The present invention has an object to provide a manufacturing method of a long large-diameter composite cemented carbide roll and a hot rolling method of steel using the same. The roll manufacturing method covers a composite cemented carbide roll formed by engaging with, and fixing to, a steel arbor, a sleeve comprising an outer layer made of a cemented carbide formed by integrating a plurality of previously sintered cylindrical formed members and an inner layer made of a steel material formed on the inner surface of the outer layer. The sleeve has a sectional area ratio So/Si of the sectional area So of the outer layer and the sectional area Si of the inner layer in a cross-section perpendicular to the rotation axis within a range of from 0.3 to 20. The sleeve has a length within a range of from 520 to 6,000 mm. When hot-rolling steel, the cemented carbide rolls of the invention are used as work rolls of at least one stand for a roughing mill and/or a finishing mill.

### TECHNICAL FIELD

The present invention relates to a composite cemented carbide roll having an outer layer sleeve comprising a cemented carbide, an inner layer sleeve comprising a steel material, and a steel arbor. The invention relates also to a hot rolling method of steel using cemented carbide rolls, particularly to a hot rolling method of steel on a roughing mill or a finishing mill.

### BACKGROUND ART

Work rolls incorporated in a hot rolling mill of steel (hereinafter referred to as “rolls”) are required to satisfy the following performance requirements:

(1) Wear resistance and cracking resistance: The roll should be resistant to wear and hardly susceptible to cracks, a cutout or a depression;

(2) Surface deterioration resistance: Surface deterioration should hardly occur in rolled products; and

(3) Thermal crown (a projecting swelling of the roll barrel caused by thermal expansion) is small.

A steel roll used commonly is insufficient in the above-mentioned properties such as wear resistance and surface deterioration resistance. In addition, the steel roll has a defect in that the thermal crown is large and improvement of size and shape accuracy of a rolled steel is limited.

As a roll excellent in wear resistance and surface deterioration resistance, for example, Japanese Unexamined Patent Application Publication No. 10-5825 discloses a composite cemented carbide roll in which, as shown in FIGS. 11A and 11B, a sleeve having an outer layer 11 made of a cemented carbide and an inner layer 2 made of a steel material is fixed by engaging with a steel arbor.

In the roll disclosed in Japanese Unexamined Patent Application Publication No. 10-5825, the ratio of the sectional area of the outer layer 11 to the sectional area of the inner layer 2 in a cross-section perpendicular to the rotation axis is 0.7 or less, and a compressive stress of 100 MPa or higher is maintained in the outer layer circumferential direction. Through these measures, occurrence of cracks in the outer layer comprising a cemented carbide weak against impact and tensile stress is to be inhibited.

In the roll disclosed in Japanese Unexamined Patent Application Publication, the ratio So/Si of the sectional area So of the outer layer 11 to the sectional area Si of the inner layer 2 is 0.7 or less. The thickness of the outer layer 11 of the sleeve is therefore smaller than the thickness of the inner layer 2. This has resulted in a problem of a short roll service life before becoming a decommissioning diameter since there has been available only a small margin for roll grinding.

When manufacturing a large-diameter long roll having the structure disclosed in Japanese Unexamined Patent Application Publication No. 10-5825, it is necessary to prepare a long outer layer sleeve 11 formed integrally made of a cemented carbide. The cemented carbide sleeve is formed by sintering mixed cemented carbide powder. Contraction of the volume by about 50% during the sintering process results in a very large change in size in the course of sintering the integrally formed sleeve. Because the contraction ratio during sintering varies, a person skilled in the art usually manufactures the sleeve so that the sleeve size after sintering is slightly larger than the target size, and the sleeve is then finished by grinding into the target size. For example, when forming a long integrally formed cemented carbide outer layer 11, for example, having an outside diameter of 600 mm and a length of 520 mm or longer through sintering, the amount of grinding of the sleeve outer layer 11 becomes large, leading to an increase in the amount of grinding, and this resulted in a problem of a lower manufacturing yield of cemented carbide ([weight of sleeve outer layer]/[weight of the mixed cemented carbide powder filling the formed member]).

It is difficult to uniformly sinter a long sleeve made of a cemented carbide. Fine pores tended to easily remain in the sleeve, and when rolling, this posed a problem in that cracks propagated from fine pores produced during sintering and cracks occurred in the sleeve outer layer 11.

Japanese Unexamined Patent Application Publication No. 10-263627 discloses a composite cemented carbide roll as shown in FIGS. 12A and 12B which largely reduces changes in size after sintering and permits manufacture of large-diameter long rolls in order to solve the above-mentioned problems.

In the roll disclosed in Japanese Unexamined Patent Application Publication No. 10-263627, a sleeve integrally comprising a plurality of previously sintered cylindrical cemented carbide formed members is engaged with, and fixed to, a steel arbor 3. The plurality of cylindrical formed members previously subjected to a temporary sintering treatment are integrally formed through main sintering or HIP (hot isotropic pressuring). As compared with the conventional sleeve 11, a shorter sleeve 7 makes it possible to largely reduce changes in size.

However, in the composite cemented carbide roll as shown in FIGS. 12A and 12B, cracks occurred in some cases from an integral junction 7A of the formed members during engagement. When engaging and fixing the sleeve 7 with, and to, the steel arbor 3, by the shrinkage fitting process (engagement by heating the sleeve 7 side), the expansion fitting process (engagement by cooling the steel arbor 3 side) or by the combination shrinkage/expansion process (engagement by heating the sleeve 7 side and cooling the steel arbor 3 side), a tensile stress acts on the sleeve 7 both in the circumferential and axial directions as a result of thermal expansion of the low-temperature steel arbor 3. During engagement, this tensile stress may cause cracks from the integrating junction 7A of the formed members. Even when no crack occurs during engagement, tensile stress remains in the sleeve 7 after engagement and fixing of the sleeve to the steel arbor 3, and this may cause cracks during rolling, or cracks may be produced from the junction 7A.

In hot rolling of a steel sheet, in general, a steel slab is reheated in a reheating furnace to, for example, about 1,100° C., and rolled in a plurality of passes on one to three reversing roughing mills. The rough-rolled slab is then finish-rolled on a tandem finishing mill of about seven stands into steel sheet. Steel rolls are used as work rolls for the rolling mills.

Because of a higher rolling temperature in rough rolling as compared with that in finish rolling, seizure tends to easily occur between the work roll and the material, causing a problem of surface deterioration on the product steel sheet. Particularly when the rolled material is stainless steel, the thickness of the oxide film generated on the rolled surfaces during reheating and rolling is smaller than that of ordinary steel, seizure tends to occur more easily.

In rough rolling, cracks tend to easily occur on the surfaces of the work rolls under a rolling reaction (rolling load), thermal stress, and an excessive stress resulting from a rolling abnormality. Occurrence of cracks leads to an increase in the amount of roll grinding, and hence to surface deterioration of the roll consumption. Serious cracks may cause even roll breakage (spalling).

In finish rolling, the work roll seizes the steel sheet, roughening the roll surface. If rolling is continued in this state, the roll surface roughness transfers to the surface of the rolled material, producing surface irregularities of the rolled material. At the same time, a part of the oxide film on the rolled material is pressed into the surface, and may cause a surface defect known as “surface deterioration” in which the oxide film is no removed by pickling, the next step, but remains on the surface.

In finish rolling, furthermore, a lower rolling temperature than in rough rolling leads to a larger deformation resistance of steel and a higher roll surface pressure. Because a relatively hard oxide film is produced on the steel sheet surface, the roll tends to wear more easily. This causes a problem of a higher cost resulting from a higher frequency of roll re-grinding.

Japanese Unexamined Patent Application Publication No. 9-78186 proposes a high-carbon high-speed steel roll in which the chemical composition, hardness and residual compressive stress of the roll outer shell layer are regulated as a roll for hot rolling excellent in thermal cracking resistance and wear resistance. However, use of the roll disclosed in Japanese Unexamined Patent Application Publication No. 9-78186 as a work roll on a roughing mill could not sufficiently prevent seizure or cracking as described above. Use of this roll as a work roll on a finishing mill could not sufficiently prevent the above-mentioned seizure or premature wear.

Japanese Unexamined Patent Application Publication No. 10-5825 proposes a composite cemented carbide roll in which the sectional area ratio of outer layer/inner layer of a composite roll having a two-layer sleeve comprising an inner layer made of steel and an outer layer made of a cemented carbide is regulated. The roll disclosed in Japanese Unexamined Patent Application Publication No. 10-5825 is considered to permit effective prevention of seizure or cracking described above. However, because the composite sleeve is manufactured by sintering mixed cemented carbide powder of the outer layer and simultaneously diffusion-welding the same to the inner layer, it is difficult to manufacture at a high accuracy and a satisfactory operability within a size range meeting the large-diameter long roll (for example, outside diameter 1,300 mm×rolling section barrel length 2,000 mm) such as a work roll for a hot roughing mill. The roll is not therefore applicable for work roll of a roughing mill or a finishing mill.

Japanese Unexamined Patent Application Publication No. 11-319916 proposes a method of rolling while feeding a rolling oil to prevent occurrence of seizure or cracking in work rolls of a roughing mill. However, installation of a rolling oil feeder on the roughing mill results in a higher cost.

As described above, the problems of seizure and cracking of work rolls in the roughing mill, seizure, premature wear of work rolls in the finishing mill and surface deterioration of products have not as yet been solved.

A first object of the present invention is to solve the aforementioned problems in the conventional composite cemented carbide roll. More specifically, the first object is: (1) to permit manufacture at a satisfactory yield, efficiently and without cracking even in the form of a long large-diameter roll; (2) to provide a long large-diameter composite cemented carbide roll which does not crack in use in any of various type of rolling including cold tandem rolling, hot roughing, hot finishing, plate rolling and section rolling; and (3) to provide a long large-diameter composite cemented carbide roll which ensures a high control accuracy of size and shape of the rolled material and permits stable rolling.

A second object of the invention is to provide a rolling method which prevents occurrence of roll seizure, cracking or wear in hot rolling of steel.

Disclosure of Invention

The present invention was developed on the basis of the following findings. By preparing a cemented carbide sleeve through integration of a plurality of previously sintered short cylindrical formed members, it is possible to efficiently manufacture a composite cemented carbide roll at a high yield even in the case of a long large-diameter roll. This cemented carbide sleeve can be manufactured while inhibiting generation of pores which may develop into cracks. By diffusion-welding an inner layer comprising a steel material onto the inner surface of this cemented carbide sleeve, it is possible to reduce tensile stress in the axial direction of the cemented carbide sleeve, thus permitting prevention of cracking.

An aspect of the invention provides a composite cemented carbide roll having a sleeve comprising a cemented carbide outer layer formed integrally from a plurality of previously sintered cylindrical formed members and an inner layer made of a steel member formed on the inner surface of the outer layer, fixed through engagement with a steel arbor; wherein the sleeve has a length within a range of from 520 to 6,000 mm.

In the above-mentioned composite cemented carbide roll, the number of the formed members should preferably be within a range of from 5 to 30.

The ratio of the sectional area of the outer layer to the sectional area of the inner layer of the sleeve in a cross-section perpendicular to the rotation axis is limited within a prescribed range. By using a thicker outer layer made of a cemented carbide and a thinner inner layer made of a steel material, the sleeve is prevented from cracking during engagement in the manufacturing process or during rolling.

More specifically, the invention provides a composite cemented carbide roll having a sleeve comprising a cemented carbide outer layer formed integrally from a plurality of previously sintered cylindrical formed members and an inner layer made of a steel member formed on the inner surface of the outer layer, fixed through engagement with a steel arbor; wherein the sleeve has a ratio So/Si of the sectional area So of the outer layer to the sectional area Si of the inner layer in the cross-section perpendicular to the rotation axis within a range of from 0.3 to 20.

In the invention, the ratio So/Si of the sectional area So of the outer layer to the sectional area Si of the inner layer should preferably be within a range of from 0.8 to 15.

The above-mentioned composite cemented carbide roll should preferably be used as a work roll for a cold tandem mill with an outside diameter limited within a range of from 150 to 800 mm; as a work roll for a hot roughing mill with an outside diameter limited within a range of from 500 to 1,500 mm; as a work roll for a hot finishing mill with an outside diameter limited within a range of from 400 to 1,400 mm; as a work roll for a plate mill with an outside diameter limited within a range of from 500 to 1,500 mm; or as a work roll for a section mill with an outside diameter limited within a range of from 600 to 2,000 mm.

The invention provides also a hot rolling method of steel, comprising the step of using, upon hot rolling steel, rolls having a cemented carbide surface layer in their barrel as work rolls for at least a stand of a roughing mill.

The invention provides also a hot rolling method of steel, comprising step of using, upon hot rolling steel, rolls having a cemented carbide surface layer in their barrel as work rolls for at least a stand of a finishing mill.

In the invention, the roll comprises an outer layer sleeve made of a cemented carbide, an inner layer sleeve made of a steel material, and a steel arbor. The outer layer sleeve should preferably be integrally formed by connecting a plurality of cemented carbide formed members in the roll axial direction.

### BRIEF DESCRIPTION OF THE DRAWINGS

FIG. 1 is a schematic sectional view in the rotation axis direction of the composite cemented carbide roll of the present invention;

FIG. 2 is a schematic sectional view in a direction perpendicular to the rotation axis of the composite cemented carbide roll of the invention;

FIG. 3 is a perspective view illustrating a manufacturing process of the sleeve used in the invention;

FIG. 4 is a sectional view illustrating a manufacturing process of the sleeve used in the invention;

FIG. 5 is a sectional view illustrating a manufacturing process of the roll used in the invention;

FIG. 6 is a graph illustrating the relationship between the number of formed members and the manufacturing yield of a cemented carbide in an example of the invention;

FIG. 7 is a graph illustrating the relationship between the number of formed members and the ratio of cracking of the sleeve outer layer in an example of the invention;

FIG. 8 is a graph illustrating the relationship between the number of formed members and the ratio of cracking of the sleeve in a conventional example;

FIG. 9 is a graph illustrating the relationship between the sectional area ratio of the sleeve and the ratio of cracking of the sleeve in a range of large sectional area ratios;

FIG. 10 is a graph illustrating the relationship between the sectional area ratio of the sleeve and the ratio of cracking of the sleeve in a range of small sectional area ratios;

FIG. 11A is a schematic sectional view in the rotation axis direction of a conventional composite cemented carbide roll;

FIG. 11B is a schematic sectional view in a direction perpendicular to the rotation axis of a conventional composite cemented carbide roll;

FIG. 12A is a schematic sectional view in the rotation axis direction of another conventional composite cemented carbide roll;

FIG. 12B is a schematic sectional view in a direction perpendicular to the rotation axis of another conventional composite cemented carbide roll;

FIG. 13 is a schematic sectional view illustrating a typical roll suitable for application of the invention; and

FIG. 14 is a layout drawing illustrating a typical hot rolling line suitable for application of the invention.

### BEST MODE FOR CARRYING OUT THE INVENTION

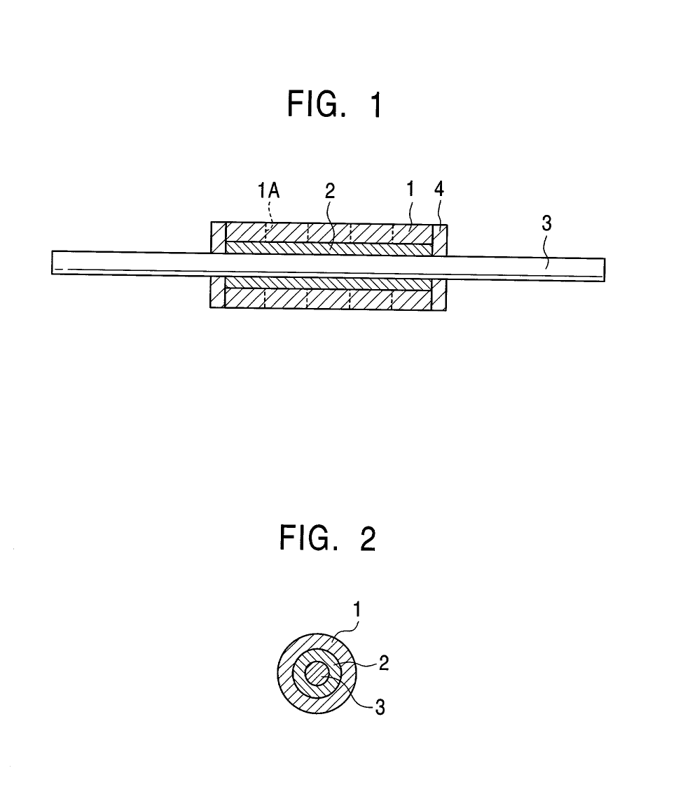

FIG. 1 is a schematic sectional view in the rotation axis direction of the composite cemented carbide roll of the present invention; and FIG. 2 is a schematic sectional view in a direction perpendicular to the rotation axis of the composite cemented carbide roll of the invention. In FIGS. 1 and 2, 1 represents an outer layer; 2, an inner layer; 3, an arbor; and 1A, a junction where previously sintered formed members are integrally formed. The junction is not discernible in an exterior view or even by an ultrasonic flaw detecting test. The composite cemented carbide roll of the invention comprises a sleeve having an outer layer 1 made of a cemented carbide and an inner layer 2 made of a steel material diffusion-welded onto the inner surface of the outer layer 1 is engaged with, and fixed to, a steel arbor. The steel arbor 3 is longer than the sleeve for attaching bearings to the both ends thereof. The sleeve is engaged at the length center of the steel arbor and fixed there. In FIG. 1, the outer layer 1 made of a cemented carbide and the inner layer 2 made of a steel material diffusion-welded to the inner surface of the outer layer 1 are formed so as to have the same length, and steel side end rings are attached to the both ends of the sleeve.

In the invention, the outer layer 1 made of a cemented carbide is formed by integrally connecting a plurality of previously sintered cylindrical formed members, and a sleeve is formed by diffusion-welding the inner layer 2 made of a steel material to the inner surface of the outer layer 1. A feature of the invention is that the length of this sleeve is limited within a range of from 520 to 6,000 mm. Another feature of the sleeve is that, on a cross-section perpendicular to the rotation axis as shown in FIG. 2, the ratio So/Si of the outer layer sectional area So to the inner layer sectional area Si should be within a range of from 0.3 to 20.

The cemented carbide of the outer layer 1 is prepared by sintering a mixed cemented carbide powder made by adding from to 50 mass % one or more selected from the group consisting of metal powder of Co, Ni, Cr and Ti to powder of a cemented carbide such as WC, TaC and TiC. A mixed cemented carbide powder prepared by mixing from 5 to 50 mass % Co powder to WC is preferable because of excellent wear resistance and surface deterioration resistance and a satisfactory toughness. This cemented carbide has a small thermal expansion coefficient (linear expansion coefficient) as about a half that of the conventional materials such as high-speed steel and semi-high-speed steel. Because of the high hardness, the extent of being flattened under a load applied during rolling is smaller as compared with rolls made of the conventional high-speed steel and semi-high-speed steel. The contact arc length between the roll and the rolled material becomes therefore shorter, thus reducing the contact time resulting from roll rotation during rolling. An available advantage is that this reduces the heat input into the roll, with a low thermal expansion coefficient, leading to a smaller thermal crown. A smaller absolute amount of thermal crown is desirable since it permits improvement of the size and shape control accuracy of the rolled material. The steel material of the inner layer 2 should preferably be any of cast steel, gorged steel, graphite cast steel, carbon steel and alloy carbon steel. The arbor 3 can be prepared by tempering chromium steel, chromium-molybdenum steel or high-speed steel.

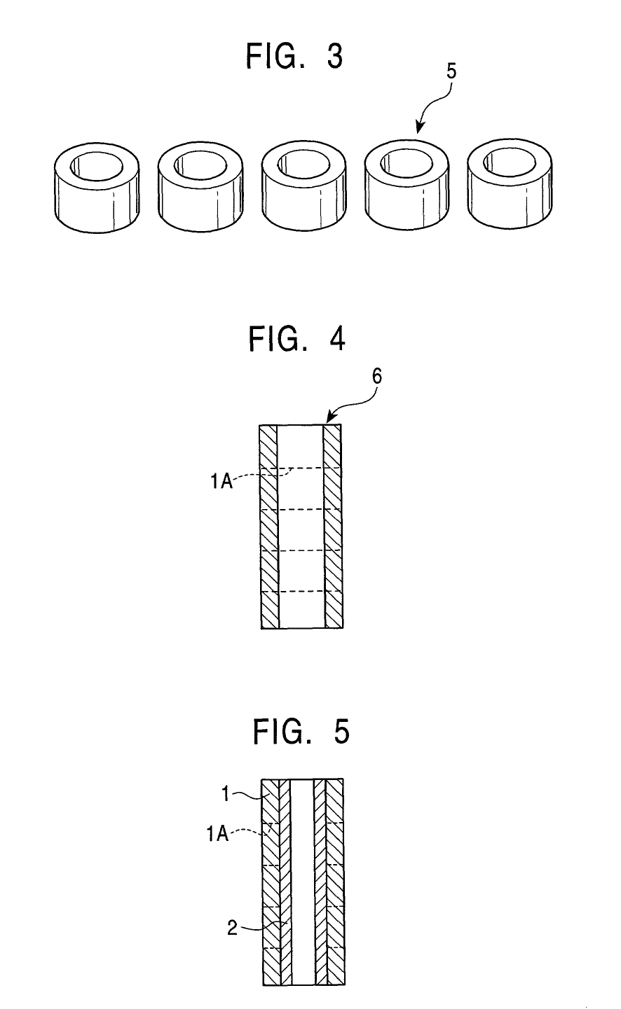

A manufacturing method of the composite cemented carbide roll of the present invention will now be described with reference to FIGS. 3 to 5.

FIG. 3 is a perspective view illustrating a plurality of formed members 5 used for the sleeve of a composite cemented carbide roll; and FIGS. 4 and 5 are sectional views illustrating the process of forming a sleeve by forming an inner layer 2 made of a steel material on the inner surface of the cemented carbide sleeve 6 prepared by integrally connecting a plurality of previously sintered cylindrical formed members 5.

The composite cemented carbide roll of the invention can be manufactured through steps, for example, of charging the powder (preparing a plurality of formed members per roll)→CIP (cold isotropic pressuring) treatment→machining→temporary sintering→machining→main sintering and HIP treatment (integrally connecting a plurality of formed members, and preparing a cemented carbide sleeve 6)→machining→diffusion welding (diffusion-welding a steel cylindrical inner layer member to the inner surface of the cemented carbide sleeve 6)→engagement and fixing (engaging the sleeve with the steel arbor and fixing there).

The formed members are prepared by mixing a cemented carbide material powder and a metal powder, and filling the gap between the outer cylinder and the inner cylinder with the resultant mixed cemented carbide material powder. The resultant hollow formed members are temporarily sintered, and as required after temporary sintering, the formed members are machined into hollow cylindrical formed members 5 as shown in FIG. 3. Preferable temporary sintering conditions include a temperature within a range of from 550 to 800° C. and a holding time of from 1 to 3 hours.

For the purpose of increasing density of the hollow formed members 5, it is desirable to apply a CIP treatment prior to temporary sintering. The CIP forming conditions include, for example, a pressure within a range of from 100 to 300 MPa and a holding time within a range of from 5 to 60 minutes.

A plurality of the thus obtained hollow formed members placed one on top of the other are integrated through diffusion welding by main sintering and an HIP treatment to prepare a cemented carbide sleeve 6 as shown in FIG. 4. The main sintering and the HIP treatment are accomplished, for example, in an Ar atmosphere, under a pressure within a range of from 100 to 200 MPa at a temperature within a range of from 1,100 to 1,200° C. by holding for a period of from 0.5 to 2 hours, and then further holding at a temperature of from 1,300 to 1,350° C. for 1 to 3 hours. By diffusion-welding a steel cylindrical inner layer member to the inner surface of this sleeve, a sleeve as shown in FIG. 5 is obtained. When diffusion-welding a forged steel corresponding to a cylindrical SCM-440 having a thickness of 50 mm onto the inner surface of a cemented carbide sleeve 6, a treatment is applied in an Ar atmosphere at a temperature of from 1,200 to 1,300° C. for a holding time of from 0.5 to 1 hour. As required, the sleeve is subjected to a machining such as grinding or polishing. Then, the sleeve is engaged with, and fixed to, the arbor by an ordinary process such as shrinkage fitting or expansion fitting.

In the invention, as described above, the cemented carbide sleeve is formed by integrating the plurality of previously sintered cylindrical formed members 5 through main sintering and the HIP treatment. The sleeve after integration has therefore a high size accuracy. It is therefore possible to reduce the amount of grinding, resulting in a satisfactory manufacturing yield of cemented carbide and a high production efficiency. It is, for example, possible to manufacture a long large-diameter roll having a diameter of 600 mm and a sleeve length of 520 mm or more.

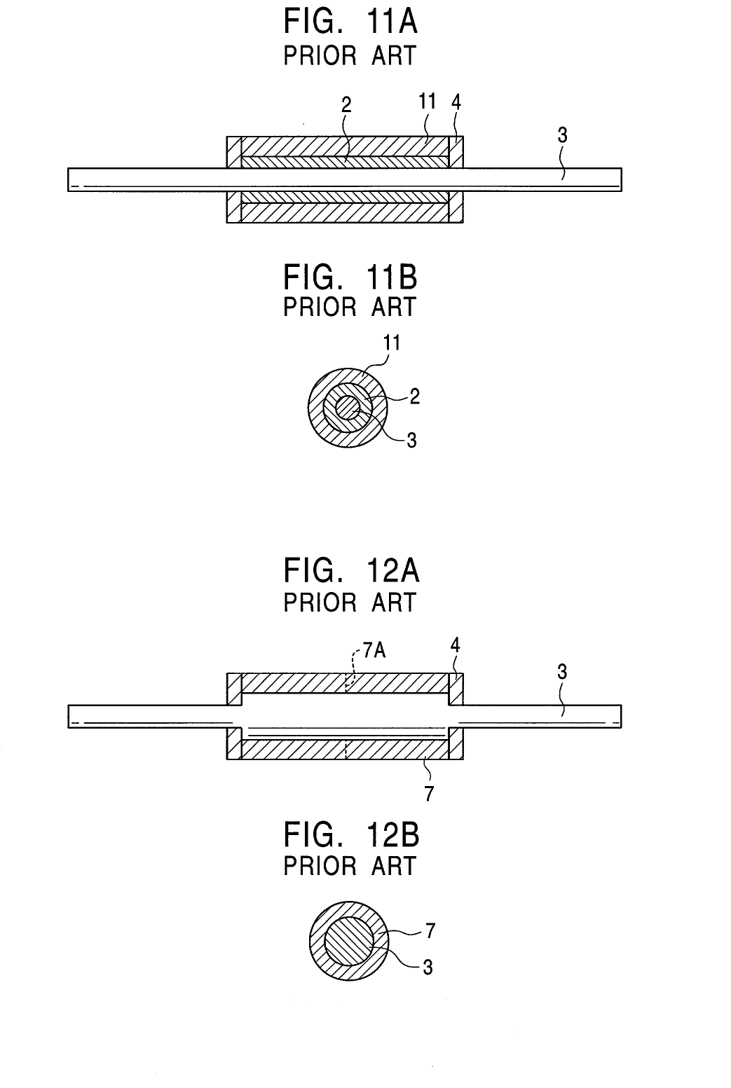

In contrast, when manufacturing an outer layer of a long sleeve comprising integrally formed cemented carbide members by sintering, as shown in FIGS. 11A and 11B, a larger amount of grinding of the sleeve is required after sintering. This results in a larger grinding load, requiring a very long period of time for grinding. Because of the low manufacturing yield of the cemented carbide powder, it is difficult to economically manufacture efficiently a long large-diameter roll having, for example, a diameter of 600 mm, and a sleeve length of 520 mm or more.

In the invention, furthermore, a two-layer sleeve is formed by diffusion-welding an inner layer sleeve made of a steel material onto the inner surface of a cemented carbide outer layer sleeve. It is possible to inhibit cracking of the sleeve even during engagement in the manufacturing process or during rolling, as compared with a cemented carbide sleeve 7 having no steel material on the inner surface thereof shown in FIGS. 12A and 12B.

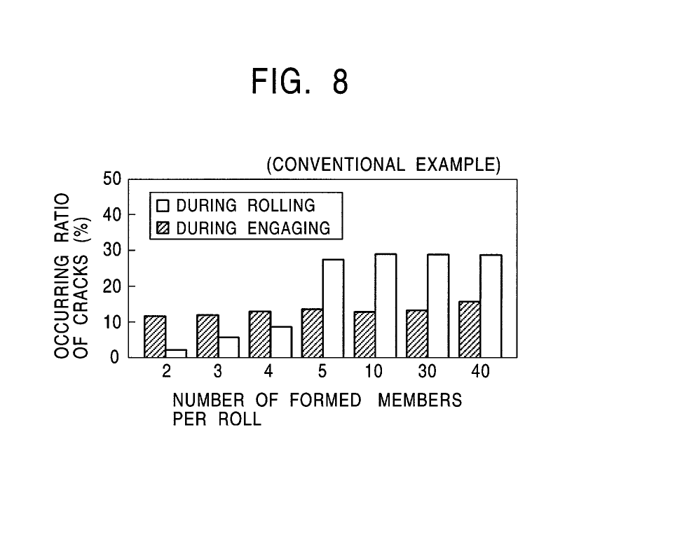

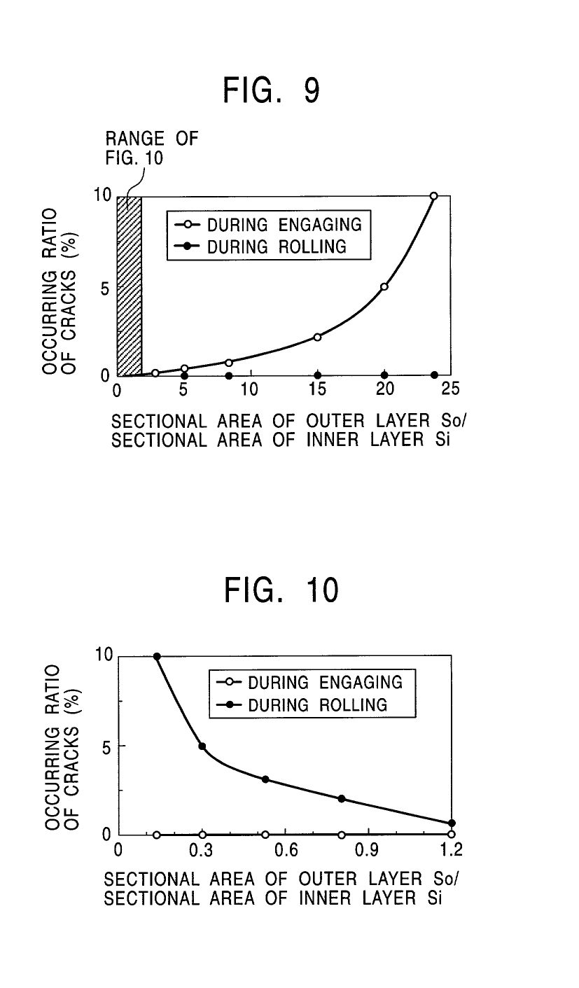

FIG. 7 illustrates the cracking ratio of the sleeve outer layer of the roll of the invention. FIG. 8 illustrates the cracking ratio of the sleeve of the conventional composite cemented carbide roll. The definition of the cracking ratio is the same as in the description of FIG. 9. Comparison of FIGS. 7 and 8 clearly demonstrates that the cracking ratio is lower for the sleeve outer layer of the roll of the invention. The cracking ratio for the sleeve outer layer of the roll of the invention is lower since a compressive stress acts on the sleeve outer layer.

The compressive stress acts on the outer layer sleeve for the following reasons. When cooling the sleeve after diffusion-welding the steel inner layer member to the inner surface of the cemented carbide sleeve at a high temperature, the amount of shrinkage becomes larger because of the thermal expansion coefficient of the steel inner layer member larger than that of the cemented carbide sleeve, and this difference in the amount of shrinkage produces a tensile stress in the inner layer, and a compressive stress in the outer layer.

Both FIGS. 7 and 8 illustrate the results of investigation of a roll for a cold tandem mill having an outside diameter of 560 mm, a barrel length of 1,800 mm, and a total length of 3,500 mm.

The relationship between the number of formed members per roll and the manufacturing yield of mixed cemented carbide powder, and the number of formed members per roll as well as the cracking ratio of the sleeve outer layer during engagement when manufacturing the composite cemented carbide roll of the invention by the above-mentioned method were investigated. Furthermore, the cracking ratio of the sleeve outer layer during rolling was studied by subjecting composite cemented carbide rolls which could be manufactured without cracking during manufacturing.

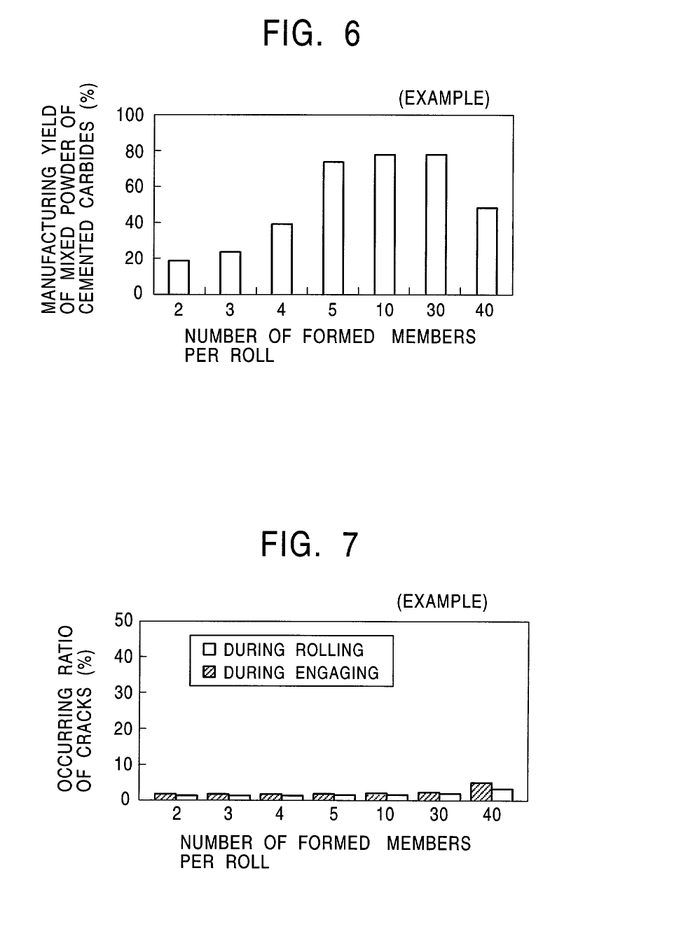

FIGS. 6 and 7 shown the results, respectively. FIG. 6 is a graph illustrating the relationship between the number of formed members per roll and the manufacturing yield of cemented carbide in an example of the invention; and FIG. 7 is a graph illustrating the number of formed members per roll, the cracking ratio of the sleeve outer layer during engagement, and the cracking ratio of the sleeve outer layer during rolling in an example of the invention. In FIG. 6, the manufacturing yield of cemented carbide is calculated by dividing the weight of the cemented carbide sleeve by the charged weight of the mixed cemented carbide powder charged into the (plurality of) formed members.

The result illustrated in FIG. 6 was obtained for the following reasons. When the number of formed members is under five, the longer barrel length per formed member leads to a large thermal shrinkage resulting from cooling after sintering. Slightly larger formed members would be manufactured with a margin, and moreover, the shape of shrinkage becomes warped. The amount of grinding in the course of manufacture of the cemented carbide sleeve increases, with surface deterioration of the manufacturing yield of the cemented carbide. When the number of formed members is over 30, on the other hand, there would be more surfaces in contact of the piled formed members, leading to a corresponding increase in the amount of grinding of the cemented carbide sleeve, thus resulting in a poorer manufacturing yield of the cemented carbide.

The result shown in FIG. 7 reveals that a number of formed members per roll over 30 corresponds to an increase in the cracking ratio. The increase in the number of surfaces in contact of the formed members leads to easier cracking starting therefrom. It is needless to mention that a larger amount of grinding results in a longer grinding time and hence in a lower production efficiency.

With a view to improving the manufacturing yield of cemented carbide, and inhibiting cracking of the cemented carbide sleeve during engagement and during rolling, in the composite cemented carbide roll of the invention, as described above, the number of formed members should preferably be within a range of from 5 to 30.

The reasons of limiting the ratio So/Si of the sectional area of the sleeve outer layer to the sectional area Si of the inner layer in a cross-section perpendicular to the rotation axis (hereinafter also referred to simply as the “sectional area ratio”) within the above-mentioned range will be described.

The present inventors carried out an experiment of use in cold tandem mill by manufacturing a roll for cold tandem mill, having an outside diameter of 560 mm, a barrel length of 1,800 mm, and a total length of 3,500 mm. A cemented carbide sleeve formed through integration of six previously sintered cylindrical formed members was prepared for this experiment. The total of the thickness of the cemented carbide outer layer and the thickness of the steel inner layer diffusion-welded to the inner surface thereof was kept constant at 150 mm, and a plurality of rolls under these conditions, with the sectional area ratio So/Si ranging from 0.12 to 25. They studied the cracking ratio on the sleeve outer layer during engagement of the sleeve with the steel arbor. When the sleeve was not cracked, two rolls in a set were subjected to cold rolling to investigate the cracking ratio in the sleeve outer layer during rolling. The cracking ratio during engagement of the sleeve with the steel arbor and the cracking ratio during rolling were determined as follows.

Two hundred rolls were engaged at respective sectional ratios So/Si shown in FIGS. 9 and 10. A cracking ratio of 1% during engagement means that cracking occurred twice during engagement for 200 rolls engaged and manufactured. Additional rolls were manufactured in a number equal to that of rolls having cracked during engagement. Two hundred rolls (100 sets) were subjected to rolling with respective sectional area ratios So/Si shown in FIGS. 9 and 10. For example, a cracking ratio of 2% during rolling means that, from among the 100 sets of roll subjected to rolling, cracks were produced in one or both rolls for two sets.

Cracking ratios in the sleeve outer layer during engagement of the sleeve with the steel arbor and during rolling are represented in FIGS. 9 and 10. FIG. 10 shows an enlarged view of the region of smaller sectional area ratios So/Si in FIG. 9.

It is known from FIGS. 9 and 10 that the cracking ratio in the sleeve outer layer during engagement is 0 for a small sectional area ratio So/Si, increases according as the sectional area ratio So/Si increases, and steeply increases when the sectional area ratio So/Si exceeds 20. The cracking ratio in the sleeve outer layer during rolling, on the other hand, is 0 for a large sectional area ratio So/Si, increases according as the sectional area ratio So/Si decreases, and steeply increases when the sectional area ratio So/Si becomes under 0.3.

In the invention, therefore, with a view to preventing cracking in the sleeve outer layer during engagement, the sectional ratio So/Si should be 20 or lower, or preferably, or lower. For preventing cracking in the sleeve outer layer during rolling, on the other hand, the sectional area ratio So/Si should be 0.3 or higher, or preferably, 0.8 or higher.

For the reasons as described above, in the invention, the ratio So/Si of the sectional area So of the sleeve outer layer to the sectional area Si of the inner layer 2 should be within a range of from 0.3 to 20, or preferably, from 0.8 to 15.

When the sleeve sectional area ratio So/Si is 0.8 or higher within the range of the invention, it is possible to adopt a larger thickness for the outer layer 1 made of the cemented carbide, even if the sleeve thickness is the same as in the conventional composite cemented carbide roll which should have a sectional area ratio of 0.7 or under. As a result, the margin for roll grinding becomes larger, allowing reduction of the critical diameter for decommissioning and extension of the roll service life. Because of the possibility to use a larger thickness for the outer layer 1 made of the cemented carbide, the roll strength increases, and it is possible to subject the roll to rolling under a higher rolling load.

Application of the composite cemented carbide roll of the invention as a work roll for a cold tandem mill with an outside diameter within a range of from 150 to 1,500 mm ensures a remarkable improvement of heat scratch resistance and surface gloss of the rolled material as compared with the conventional steel roll. Application of the composite cemented carbide roll of the invention as a work roll for a hot roughing mill with an outside diameter within a range of from 5,000 to 1,500 mm ensures a remarkable improvement of size and shape control property by reduction of thermal crown as compared with the conventional steel roll.

Application of the composite cemented carbide roll of the invention as a work roll for a hot finishing mill with an outside diameter within a range of from 400 to 1,400 mm ensures a remarkable improvement of size and shape control property by reduction of thermal crown as compared with the conventional steel roll.

Application of the composite cemented carbide roll of the invention as a work roll for a plate mill with an outside diameter within a range of from 500 to 1,500 mm ensures a remarkable improvement of size and shape control property by reduction of thermal crown as compared with the conventional steel roll.

Application of the composite cemented carbide roll of the invention as a work roll for a section mill with an outside diameter within a range of from 600 to 2,000 mm ensures a remarkable improvement of size and shape control property by reduction of thermal crown as compared with the conventional steel roll. In all cases including the uses described above, wear resistance, cracking resistance and surface deterioration resistance are remarkably improved as compared with the conventional steel roll.

In the present invention, the rolls having rolling section surface layer made of a cemented carbide are used as work rolls for at least a stand of a roughing mill. The cemented carbide is prepared by sintering a mixed cemented carbide powder obtained by adding, in an amount of from 5 to 50 mass %, one or more selected from the group consisting of metal powder materials of Co, Ni, Cr and Ti to cemented carbide powder of WC, TaC or TiC. The mixed cemented carbide powder should preferably be one prepared by sintering WC −5 to 50 mass % Co powder which is preferable because of excellent wear resistance and surface deterioration resistance and a satisfactory toughness.

This inhibits surface deterioration caused by seizure on the steel sheet surface after hot rolling. In a stand using such rolls as work rolls, cracking does not occur and progress of wear is inhibited even without supply of rolling oil.

The roll used in the invention has an arbor, an inner layer sleeve made of a steel material, and an outer layer sleeve member made of a cemented carbide. The outer layer sleeve member should preferably be formed by integrally connecting a plurality of cemented carbide formed members in the roll axial direction. This makes it possible to manufacture the sleeve member at a high accuracy and with a satisfactory operability. This roll has an inner layer sleeve made of a steel material between the arbor and the cemented carbide connected sleeve.

As compared with direct connection of the cemented carbide connected sleeve and the arbor by shrinkage fit or expansion fit, tensile stress acting in the axial direction of the cemented carbide connected sleeve after completion can be alleviated, and this is favorable for preventing cracking of the cemented carbide connected sleeve during manufacture and during rolling.

The manufacturing method of the above-mentioned cemented carbide connected sleeve comprises the steps of rubber-forming a plurality of hollow members (cemented carbide formed members) divided along a plane crossing the roll center axis, and after temporarily sintering, integrating the hollow members by HIP (hot isotropic pressuring) connection. According to this method, the hollow members in the temporary sintering are reduced in size, so that production of thermal strain is inhibited, and even when manufacturing a sleeve for a large-diameter long roll such as a work roll for a hot roughing mill, manufacture can be performed at a high operability, giving products of a high size accuracy.

The arbor comprises a metal shaft material such as cast steel, forged steel or cast iron as is commonly used.

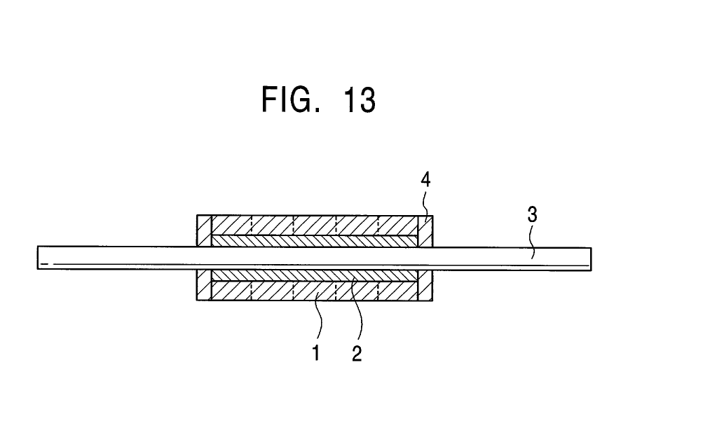

FIG. 13 is a schematic sectional view illustrating a typical roll suitable for application of the invention. The cemented carbide connected sleeve 1 is engaged with the barrel of the steel arbor 3 via the inner layer sleeve 2 made of a steel material and fixed with a steel side end ring 4.

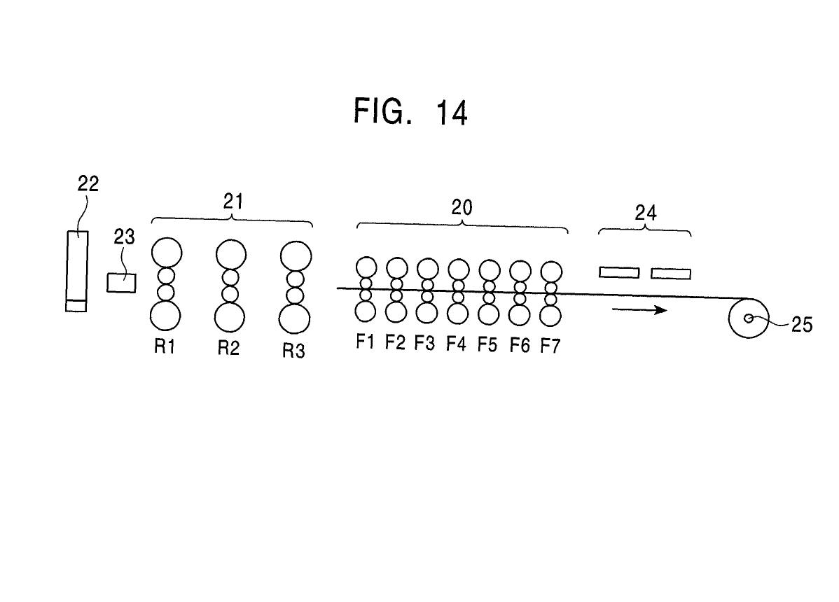

FIG. 14 is a layout drawing illustrating a typical hot rolling line suitable for application of the invention. Sequentially from the line upstream side, a reheating furnace 22, a width press apparatus 23, a roughing mill 21, a finishing mill 20, a cooling system 24 and a coiler 25 are arranged. In this example, the roughing mill 23 is composed of three stands R1, R2 and R3, and the finishing mill 20 is composed of seven stands F1, F2, . . . , F7. When a roughing mill comprises a plurality of stands as in this case, it is desirable to apply the invention to the upstream side stands in which the rolled material temperature is higher. In the finishing mill, the stands to which the cemented carbide roll is applied should preferably be stands on the latter stage side on which the amount of scale becomes larger. A better result is available according as stands to which the roll of the invention is applied are increased in number in response to availability of economic margin.

### Example 1

As Example 1 of the invention, two rolls for a cold tandem mill, each having an outside diameter of 560 mm, a barrel length of 1,800 mm and a total length of 3,500 mm, as shown in FIGS. 1 and 2, were manufactured. The manufacturing yield of the cemented carbide when manufacturing the sleeve, the status of cracking on the sleeve outer layer during engagement, and the total period of time consumed for grinding each roll made of the cemented carbide were investigated.

In the example 1 of the invention, a cemented carbide sleeve was prepared by coaxially piling six previously sintered cylindrical formed members per roll, then subjecting the members to main sintering and an HIP treatment, and integrating them-. A cylindrical inner layer member made of a molten steel material was diffusion-welded to the inner surface of this cemented carbide sleeve. The resultant sleeve was engaged with the steel arbor and fixed thereto to manufacture two composite cemented carbide rolls.

The formed members were prepared as follows. WC powder having the chemical composition shown in Table 1 and an average particle size within a range of from 3 to 5 μp and Co metal powder having an average particle size within a range of from 1 to 2 μm were mixed together with WC balls as mixing medium for two days. Formed members were prepared by filling the gap between double-cylindrical rubber die outer cylinder and inner cylinder with the resultant mixed cemented carbide powder. The double cylindrical rubber die outer cylinder has an inside diameter of 835 mm and a length of 425 mm, and the inner cylinder has an outside diameter of 350 mm and a length of 425 mm. A pipe-shaped spindle having a diameter of 345 mm and a length of 500 mm was inserted into the center portion of the double-cylinder, and a rubber die was placed on a hammer-type charging machine. A series of processes of charging the mixed powder of cemented carbide material in batches of equal amounts, and then pressurizing the same were repeated.

Other detailed conditions are shown in Table 1.

The treatment conditions for diffusion-welding the cylindrical inner layer Member made of a molten steel material to the inner surface of the cemented carbide sleeve are shown in Table 2.

An example 2 of the invention was carried out in the same manner as in example 1 of the invention except that four previously sintered formed members were used, and each formed member had a length as shown in Table 1. As in example 1 of the invention, the manufacturing yield of the cemented carbide when manufacturing the sleeve, the status of cracking on the sleeve outer layer during engagement, and the total period of time consumed for grinding each roll made of the cemented carbide were investigated.

In the example 2 of the invention, the outer cylinder and the inner cylinder had a length of 640 mm, and charging was accomplished by appropriately changing the length of the pipe-shaped spindle.

The composite cemented carbide roll of a conventional example 1 having structure as shown in FIGS. 12A and 12B was manufactured under conditions shown in Table 1, and as in the example 1 of the invention, the manufacturing yield of the cemented carbide when manufacturing the sleeve, the status of cracking on the sleeve outer layer during engagement, and the total period of time consumed for grinding each cemented carbide roll were investigated.

The formed members were prepared in the same manner as in the example 1 of the invention, except that the outer cylinder of the double-cylinder rubber die had an inside diameter of 835 mm and a length of 2,800 mm, and the inner cylinder had an outside diameter of 350 mm. A pipe-shaped spindle having a diameter of 345 mm was inserted with various appropriate lengths into the center portion of the double cylinders.

The composite cemented carbide roll of the conventional example 2 having the structure shown in FIGS. 11A and 11B was manufactured under conditions shown in Table 1, and as in the example 1 of the invention, the manufacturing yield of the cemented carbide when manufacturing the sleeve, the status of cracking on the sleeve outer layer during engagement, and the total period of time consumed for grinding each roll were investigated.

Formed members were prepared in the same manner as in the example 1 of the invention. The outer cylinder of the double-cylinder rubber die had an inside diameter of 900 mm and a length of 6,000 mm, and the inner cylinder had an outside diameter of 219 mm. A pipe-shaped spindle having a diameter of 219 mm and an appropriate length was inserted into the center portion of the double cylinders.

The manufacturing yield of a cemented carbide when manufacturing the sleeve, the status of cracking on the outer layer of the sleeve during engagement, and the total period of time consumed for grinding each roll were investigated.

The result shown in Table 2 reveals that the composite cemented carbide rolls of the examples 1 and 2 of the invention are not susceptible to cracking on the sleeve outer layer during engagement of the sleeve with the steel arbor, and can be used for rolling. The result shown in Table 2 suggests also that the manufacturing yield is higher than in the conventional example 2 and the number of days required for grinding the roll can be reduced. In the case of the example 1 of the invention, in which six previously sintered formed members were used, the manufacturing yield of the mixed cemented carbide powder could be improved as compared with that in the example 2 of the invention.

The composite cemented carbide roll of the conventional example 1 showed a lower manufacturing yield of the mixed cemented carbide powder and a longer period of time for grinding the roll. Because of the production of cracks in the sleeve during engagement, the roll could not be used for rolling.

### Example 2

Composite cemented carbide rolls having the structure as shown in FIGS. 1 and 2, and the roll size shown in Table 3 and comprising the members shown in Table 4 were used as an example of the invention, and properties were investigated by incorporating them in various rolling mills.

The cemented carbide sleeve shown in Table 4 was prepared by integrating the plurality of previously sintered formed members shown in Table 5 through main sintering and an HIP treatment. The manufacturing yield of the cemented carbide powder was investigated when manufacturing the cemented carbide sleeve.

Composite cemented carbide rolls having the structure shown in FIGS. 11A and 11B and a roll size shown in Table 3 and comprising members shown in Table 4 were formed by integrating sleeve outer layers as a conventional example. Rolls having the same roll size as in the example of the invention shown in Table 3 and a roll material shown in Table 5 were used as comparative examples. Properties of these samples were investigated by incorporating the samples of the example of the invention, the conventional example and the comparative example. On a cold tandem mill, investigation was carried out by incorporating the samples into the fifth stand from among the five stands in total. On a hot finishing tandem mill, the samples were incorporated for investigation into the first and seventh stands from among seven stands in total.

Table 5 shows the critical number of rolled steels, the crack depth, the thermal crown, acceptability of shape of rolled steels in the example of the invention, the conventional example and the comparative example, and the manufacturing yield of the cemented carbide during roll manufacture in the example of the invention and the conventional example.

The roll properties in the example of the invention, the conventional example and the comparative example, and the manufacturing yield of the cemented carbide during manufacture of rolls in the example of the invention and the conventional example are shown.

The result shown in Table 5 suggests that the composite cemented carbide roll of the example of the invention in which the sleeve has a length within a range of from 520 to 6,000 mm is more excellent in the manufacturing yield of the cemented carbide powder than the composite cemented carbide roll of the conventional example. When used as a work roll for a rolling mill, the composite cemented carbide roll of the example of the invention is more excellent in wear resistance and surface deterioration resistance than the cold semi-high-speed steel roll and the hot high-speed steel roll of the comparative example. The former has therefore a larger critical number of rolled steels, a more excellent cracking resistance and a smaller thermal crown, resulting in a better shape of the rolled steels than in the roll of the comparative example.

### Example 3

Two rolls for each division for a cold tandem mill were manufactured as shown in Table 6, with an outside diameter of 560 mm×a barrel length of 1,800 mm×a total length of 3,500 mm. The manufacturing yield of the cemented carbide when manufacturing the sleeve, the status of cracking in the sleeve outer layer during engagement, and the total period of time consumed for grinding each cemented carbide roll were investigated. Not cracking rolls were subsequently subjected to rolling to investigate the rolling throughput representing the amount of rolling up to decommissioning of the roll.

In the example of the invention A1, a composite cemented carbide roll having the structure shown in FIGS. 1 and 2 was used. A cemented carbide sleeve was formed by coaxially piling six previously sintered cylindrical formed members per roll, subjecting the same to main sintering and an HIP treatment, and then integrating the same. A cylindrical inner layer member comprising a melted carbon steel was diffusion-welded to the inner surface of this cemented carbide sleeve, and a composite cemented carbide roll was obtained by engaging the resultant sleeve with a steel arbor.

Formed members were prepared as follows. WC powder having a chemical composition shown in Table 1 and an average particle size within a range of from 3 to 5 μm and Co metal powder having an average particle size within a range of from 1 to 2 μm were mixed for two days using WC balls as the mixing medium. The formed member was prepared by filling the gap between the outer cylinder and the inner cylinder of a double-cylinder rubber die with the resultant mixed cemented carbide powder. In the double-cylinder rubber die, the outer cylinder had an inside diameter of 835 mm, and a length of 425 mm, and the inner cylinder had an outside diameter of 350 mm and a length of 425 mm. A pipe-shaped spindle having a diameter of 350 mm and a length of 500 mm was inserted into the center portion of the double cylinder, and a rubber die was placed on a hammer type charging machine. A series of processes of charging the mixed cemented carbide powder in equal patches and then pressurizing the same were repeated.

Preparation of the individual formed members in the example of the invention A2 was accomplished by inserting a pipe-shaped spindle having a diameter of 490 mm and a length of 500 mm into the center portion of a double-cylinder rubber die comprising an outer cylinder having an inside diameter of 835 mm and a length of 425 mm and an inner cylinder having an outside diameter of 490 mm and a length of 425 mm.

A composite cemented carbide roll of the conventional example A3 was manufactured by using two formed members per roll with a structure shown in FIGS. 12A and 12B.

Preparation of the individual formed members in the conventional example A3 was accomplished by inserting a pipe-shaped spindle having a diameter of 350 mm and a length of 3,500 mm into the center portion of a double-cylinder rubber die comprising an outer cylinder having an inside diameter of 835 mm and a length of 2,800 mm and an inner cylinder having an outside diameter of 350 mm and a length of 2,800 mm.

A composite cemented carbide roll having the structure shown in FIG. 11A and 11B was manufactured in the conventional example A4.

Mixed cemented carbide powder was charged into a gap in which a pipe-shaped spindle having a diameter of 370 mm and a length of 6,500 mm was inserted at the center portion of a double-cylinder rubber die comprising an outer cylinder having an inside diameter of 900 mm and a length of 6,000 mm and an inner cylinder having an outside diameter of 370 mm and a length of 6,000 mm.

Table 7 shows the yield of mixed cemented carbide powder, the status of cracking in the sleeve during engagement, the number of days consumed for grinding, and the rolling throughput.

It is known from the result shown in Table 7 that the composite cemented carbide rolls of the examples of the invention A1 and A2 are not susceptible to cracking in the sleeve outer layer during engagement, and are applicable for rolling, permit improvement of the manufacturing yield of cemented carbide over that in the conventional example A4, and makes it possible to reduce the number of days required for grinding.

In the example of the invention A1, in which the sectional area ratio was limited within a range of from 0.8 to 15, the rolling throughput could be increased as compared with the example of the invention A2 and the conventional example A4 in which the sectional area ratio was limited to 0.7 or lower.

The composite cemented carbide roll of the conventional example A3 could not be used for rolling since the manufacturing yield of the mixed cemented carbide powder was low, and cracks were produced in the sleeve outer layer during engagement.

### Example 4

Two rolls for a section mill were manufactured for each division under the conditions shown in Table 8, with an outside diameter of 1,500 mm, a barrel length of 900 mm and a total length of 3,800 mm. The manufacturing yield of the cemented carbide when manufacturing the sleeve, the status of cracking in the sleeve outer layer during engagement, and the total period of time consumed for grinding per cemented carbide roll were investigated. The sleeves not cracking were subsequently used for rolling to investigate the rolling throughput for a period of up to decommissioning of the rolls.

In the example of the invention B1, the composite cemented carbide rolls having the structure shown in FIGS. 1 and 2 were used. Five previously sintered cylindrical formed members per roll were coaxially piled, then subjected to main sintering and an HIP treatment, and integrating the same, thereby forming a cemented carbide sleeve. A cylindrical inner layer member made of cast steel was diffusion-welded to the inner surface of this cemented carbide sleeve. The resultant sleeve was engaged with the steel arbor and fixed thereto. Composite cemented carbide rolls were thus manufactured one by one.

The formed members were prepared in the same manner as in Example 1. A pipe-shaped spindle having a diameter of 960 mm and a length of 320 mm was inserted into the center portion of a double-cylinder rubber die comprising an outer cylinder having an inside diameter of 1,975 mm and a length of 255 mm and an inner cylinder having an outside diameter of 960 mm and a length of 255 mm. The rubber die was placed on a hammer type charging machine to carry out charging.

In the example of the invention B2, a sleeve was manufactured in the same manner as in the example of the invention B1, using a different sleeve sectional area ratio So/Si. In the conventional examples B3 and B4, sleeves were manufactured in the same manner as in the conventional examples A3 and A4 of the aforementioned Example 3, respectively.

Table 9 shows the yield of mixed cemented carbide powder, the status of cracking of the sleeve during engagement, the number of days required for grinding, and the rolling throughput.

It is known from the result shown in Table 9 that the composite cemented carbide rolls of the examples of the invention B1 and B2 do not suffer from cracking in the sleeve outer layer during engagement; the manufacturing yield of the cemented carbide can be improved over that in the conventional example 4; and it is possible to reduce the number of days for grinding.

In the example of the invention B1, in which the sectional area ratio was within a range of from 0.8 to 15, the rolling throughput could be increased as compared with the example of the invention B2 in which the sectional area ratio was limited to 0.7 or less, and the conventional example B4.

The composite cemented carbide roll of the conventional example B3 showed a manufacturing yield of mixed cemented carbide powder lower than in the examples of the invention B1 and B2. Since cracks occurred in the sleeve outer layer during engagement, the roll could not be applied in rolling.

### Example 5

The composite cemented carbide roll having the structure shown in FIGS. 1 and 2 was used as an example of the invention. Table 10 shows the roll size, and Table 11, the member material and the size thereof.

The cemented carbide sleeve shown in Table 11 was formed by integrating previously sintered formed members in a number shown in Table 12, through main sintering and an HIP treatment. The manufacturing yield of cemented carbide powder was investigated during manufacture of the cemented carbide sleeve.

The composite cemented carbide roll having the structure shown in FIGS. 11A and 11B was used as a conventional example. Table 10 shows the roll size, and Table 11 shows the member material and size. The sleeve outer layer is formed by integrating the formed members.

A roll having the same size as in the example of the invention shown in Table 10 and made of the material shown in Table 12 was used as a comparative example.

Properties of the example of the invention, the conventional example and the comparative example were investigated by incorporating them into various rolling mills. In a cold tandem mill, the roll was incorporated in the fifth stand from among five stands in total for investigation. Investigation was carried out on a hot finishing tandem mill by incorporating the roll in the first and seventh stands from among seven stands in total.

Table 12 shows the critical number of rolled steels, the crack depth, thermal crown, acceptability of shape of the rolled steels, the manufacturing yield of cemented carbide during roll manufacture in the example of the invention and the conventional example, and the rolling throughput up to roll decommissioning for the example of the invention, the conventional example and the comparative example.

It is known from the result shown in Table 12 that the composite cemented carbide roll of the example of the invention shows a higher manufacturing yield of the cemented carbide powder than the composite cemented carbide roll of the conventional example, and permits increase in the rolling throughput.

The composite cemented carbide roll of the example of the invention, when used as a work roll of various rolling mills, is more excellent in wear resistance and surface deterioration resistance than a cold semi-high-speed steel roll or a hot high-speed steel roll of the comparative example. It provides a larger critical number of rolled steels, is excellent in cracking resistance, and produces smaller thermal crown, resulting in a better shape of the rolled steels than in the comparative example.

### Example 6

A work roll of the material shown in Table 13 was incorporated in a roughing mill and a finishing mill on a hot rolling line shown in FIG. 14. SUS 430 ferrite-based stainless steel was rolled into 100 coils, respectively, thereby observing the surface condition of the rolled steel sheets. The crack depth of the work roll for the roughing mill was investigated.

The rolling portion of the roughing mill work roll had an outside diameter of 1,300 mm and a width of 2,000 mm. The rolling portion of the finishing mill work roll had an outside diameter of 900 mm and a width of 2,000 mm. The number of roughing passes was seven (R1×3+R2×3+R1×1).

In Table 13, “cemented carbide” means a cemented carbide roll, which has a structure shown in FIG. 13. The cemented carbide connected sleeve was manufactured from tungsten carbide (WC) to which Co is added in an amount of 20 mass % by longitudinally HIP-connecting four WC-Co alloy hollow members each having a thickness of 230 mm and a length of 500 mm formed by the rubber forming process. This sleeve was diffusion-welded to an inner layer sleeve comprising a steel material, and engaged with a steel arbor, thus obtaining a cemented carbide roll. In Table 13, “steel” means a steel roll, which was manufactured by tempering high-speed steel.

In a stand using the cemented carbide roll, only roll cooling water was supplied to the work roll, and in a stand using a steel roll, rolling was conducted while supplying roll cooling water and a rolling oil.

The result is shown in Table 13. In the example of the invention, the steel sheet surface after rolling was satisfactory, being free from surface deterioration, even without supply of a rolling oil to the cemented carbide roll. The cemented carbide roll after rolling was completely free from cracking at the hollow member connected portion as well as the other portions.

### Example 7

A work roll of the material shown in Table 14 was incorporated in a roughing mill and a finishing mill on a hot rolling line shown in FIG. 14. Ordinary low-carbon steel was rolled into 30 coils, respectively. The surface condition of the steel sheet was observed after rolling, and the crack depth of the roughing mill work roll was investigated.

The rolling portion of the roughing mill work roll had an outside diameter of 1,300 mm and a width of 2,000 mm. The rolling portion of the finishing mill work roll had an outside diameter of 900 mm and a width of 2,000 mm. The number of roughing passes was seven (R1×3+R2×3+R1×1).

The words “cemented carbide” and “steel” in Table 14 mean the same things as the words “cemented carbide” and “steel” in Table 13. In a stand using the cemented carbide roll, only roll cooling water was supplied to the work roll, and in a stand using the steel roll, rolling was conducted while supplying roll cooling water and a rolling oil.

The result is shown in Table 14. In the example of the invention, the steel sheet surface after rolling was satisfactory, being free from surface deterioration, even without supply of a rolling oil to the cemented carbide roll. The cemented carbide roll after rolling was completely free from cracking at the hollow member connected portion as well as the other portions.

### Example 8

A work roll of the material shown in Table 15 was incorporated in a roughing mill and a finishing mill on a hot rolling line shown in FIG. 14. SUS 430 ferrite-based stainless steel was rolled into 100 coils, respectively, thereby observing the surface condition of the rolled steel sheets after rolling, and the amount of wear of the finishing mill work roll (per roll radius) was investigated.

The rolling portion of the roughing mill work roll had an outside diameter of 1,300 mm and a width of 2,000 mm. The rolling portion of the finishing mill work roll had an outside diameter of 900 mm and a width of 2,000 mm. The number of roughing passes was seven (=R1×3+R2×3+R1×1).

In Table 15, “cemented carbide” means a cemented carbide roll, which has the structure shown in FIG. 13. The cemented carbide connected sleeve was manufactured from tungsten carbide (WC) to which Co is added in an amount of 20 mass % by longitudinally HIP-connecting four WC-Co alloy hollow members each having a thickness of 350 mm and a length of 500 mm formed by the rubber forming process. This sleeve was diffusion-welded to an inner layer sleeve comprising a steel material, and engaged with a steel arbor, thus obtaining a cemented carbide roll. In Table 15, “steel” means a steel roll, which was manufactured by tempering high-speed steel.

In a stand using the cemented carbide roll, only roll cooling water was supplied to the work roll, and in a stand using the steel roll, rolling was conducted while supplying roll cooling water and a rolling oil.

The result is shown in Table 15. In the example of the invention, the steel sheet surface after rolling was satisfactory, being free from surface deterioration, even without supply of a rolling oil to the cemented carbide roll. The cemented carbide roll after rolling showed almost no wear. The cemented carbide roll after rolling was free from cracking.

### Example 9

Work rolls of the material shown in Table 16 were incorporated into a roughing mill and a finishing mill on a hot rolling line shown in FIG. 14. Ordinary low-carbon steel was rolled into 100 coils, respectively. After this rolling, the surface condition of the steel sheet was observed, and the amount of wear (per roll radius) of the work roll of the finishing mill was investigated.

The rolling portion of the roughing mill work roll had an outside diameter of 1,300 mm and a width of 2,000 mm, and the rolling portion of the finishing mill work roll had an outside diameter of 900 mm and a width of 2,000 mm. The number of roughing rolling passes was seven (=R1×3+R2×3+R1×1).

The words “cemented carbide” and “steel” in Table 16 have the same meanings as the words “cemented carbide” and “steel” in Table 15. In the stand using the cemented carbide roll, only roll cooling water was supplied to the work roll, and in the stand using the steel roll, rolling was conducted while supplying roll cooling water and a rolling oil to the work roll.

The result is shown in Table 16. In the example of the invention, the steel sheet surface after rolling was satisfactory, being free from surface deterioration, even without supply of a rolling oil. The cemented carbide roll showed almost no wear. The cemented carbide roll after rolling was free from cracks.

Industrial Applicability

According to the composite cemented carbide roll of the present invention, it is possible to manufacture rolls at a high yield, efficiently, and while inhibiting cracking, even in the case of a long large-diameter roll. When applying the roll for various manners of rolling, it is possible to stably accomplish rolling while inhibiting cracking.

According to the invention, therefore, application of the cemented carbide roll to a roughing mill and a finishing mill of hot rolling as a work roll provides excellent advantages of permitting prevention of surface deterioration of steel sheet caused by seizure without the need to supply a rolling oil,. and prevention of roll cracking and wear.

TABLE 1

| | | | | CONVENTIONAL | CONVENTIONAL |
|---|---|---|---|---|---|
| ITEM | | EXAMPLE 1 | EXAMPLE 2 | EXAMPLE 1 | EXAMPLE 2 |
| ROLL CONFIGURATION | | | | | |
| | | | | 12B | 11B |
| NUMBER OF FORMED MEMBERS PER ROLL | | 6 | 4 | 2 | 1 (INTEGRALLY |
| | | | | | FORMED) |
| ROLL SIZE | | OD 560 mm × BARREL LENGTH 1,800 mm × | | | |
| | | TOTAL LENGTH 3,500 mm | | | |
| CEMENTED CARBIDE | OD (mm) | 560 | * | * | * |
| SLEEVE SIZE | ID (mm) | 335 | * | 360 | * |
| | LENGTH (mm) | 1800 | * | * | * |
| COMPOSITION OF MIXED | WC (mass %) | 85 | * | * | * |
| POWDER OF CEMENTED | Co (mass %) | 15 | * | * | * |
| CARBIDE MATERIALS | | | | | |
| INNER LAYER MEMBER | OD (mm) | 335 | * | NONE | * |
| SIZE | ID (mm) | 280 | * | | * |
| | LENGTH (mm) | 1800 | * | | * |
| INNER LAYER MEMBER MATERIAL | | GRAPHITE | * | | * |
| | | CAST IRON | | | |
| ARBOR | DRUM OD (mm) | ab.280 | * | 360 | * |
| | TOTAL LENGTH | 3500 | * | * | * |
| | (mm) | | | | |
| ABBOR MATERIAL | | 5% Cr STEEL | * | * | * |
| FORMED MEMBER SIZE | OD (mm) | 690 | * | * | INTEGRALLY |
| (AFTER CIP TREATMENT | ID (mm) | 300 | * | 250 | FORMED |
| & MACHINING) | LENGTH (mm) | 368 | 472 | 1000 | |
| CIP TREATMENT | PRESSURE | 285 | * | * | * |
| | (MPa) | | | | |
| | HOLDING TIME | 10 min | * | * | |
| TEMPORARY SINTERING | TEMP. (° C.) | 750 | * | * | NONE |
| | PRESSURE | 10⁻¹ to 10⁻² | * | * | |
| | (MPa) | | | | |
| | HOLDING TIME | 2 hrs | * | * | |
| | ATMOSPHERE | HYDROGEN | * | * | |
| | | ATM. | | | |
| MAIN SINTERING HIP | TEMP. (° C.) | 1330 | * | * | * |
| TREATMENT | PRESSURE | 100 | * | * | * |
| | (MPa) | | | | |
| | HOLDING TIME | 2 hrs | * | * | * |
| | ATMOSPHERE | Ar | * | * | * |

*: SAME CONDITIONS AS IN EXAMPLE 1

TABLE 2

| | | | | CONVENTIONAL | CONVENTIONAL |
|---|---|---|---|---|---|
| ITEM | | EXAMPLE 1 | EXAMPLE 2 | EXAMPLE 1 | EXAMPLE 2 |
| DIFFUSION | TEMP. (° C.) | 1250 | * | NONE | * |
| WELDING | PRESSURE | 100 | * | | |
| CONDITIONS | (MPa) | | | | |
| | HOLDING TIME | 1 hr | * | | |
| | ATMOSPHERE | Ar | * | | |
| RESULT OF | MANUFACTURING | 80 | 40 | 20 | 20 |
| ROLL | YIELD OF | | | | |
| MANUFACTURE | CEMENTED | | | | |
| | CARBIDE (%) | | | | |
| | SLEEVE | NONE | NONE | CRACKED | NONE |
| | CRACKING UPON | | | | |
| | ENGAGEMENT | | | | |
| | DAYS | 0.5 days | 0.8 days | 1.0 days | 3 days |
| | NECESSARY FOR | | | | |
| | GRINDING | | | | |

*: SAME CONDITIONS AS IN EXAMPLE 1

TABLE 3

| | ROLL SIZE | | |
|---|---|---|---|
| | | BARREL | |
| | DIAMETER | LENGTH | TOTAL LENGTH |
| USE | (mm) | (mm) | (mm) |
| COLD TANDEM MILL | 600 | 1800 | 3500 |
| HOT ROUGHING MILL | 1300 | 2000 | 5000 |
| HOT FINISHING MILL | 900 | 2000 | 5000 |
| PLATE MILL | 1000 | 5000 | 9000 |
| SECTION MILL | 1500 | 900 | 5000 |

TABLE 4

| | | | | | | | | | | | | PREFERABLE |
|---|---|---|---|---|---|---|---|---|---|---|---|---|
| | | | | | | | | | | | | RANGE |
| | | | | | | | | | | | | OF SLEEVE |
| | | | | | | | | | | | | THICKNESS |
| | | | | | | | | | | | | (PERRADIUS) |
| | | | | | | | | | | | | WHEN |
| | | | | | | | | | | | | ASSUMING |
| | PROPERTIES OF MEMBERS OF CEMENTED CARBIDE COMPOSITE ROLL | | | | | | | | | | | A ROLL |
| | | | | | | | | | AXIAL CORE | | | OVERALL |
| | CEMENTED CARBIDE SLEEVE | | | | INNER LAYER MEMBER | | | | | CENTER | | SIZE (OD) |
| | | OD | ID | LENGTH | | OD | ID | LENGTH | MATER- | DIAMETER | LENGTH | EQUAL TO |
| USE | MATERIAL | (mm) | (mm) | (mm) | MATERIAL | (mm) | (mm) | (mm) | IAL | (mm) | (mm) | ARBOR OD |
| COLD | WC: 80% | 600 | 320 | 1800 | GRAPHITE | 320 | 280 | 1800 | SKD11 | 280 | 3500 | 57.5 to 145 |
| TANDEM | mass | | | | CAST IRON | | | | (JIS | | | |
| MILL | Co: 20% | | | | | | | | G4404) | | | |
| HOT | mass | 1300 | 700 | 2000 | | 700 | 610 | 2000 | | 610 | 5000 | 125 to 312.5 |
| ROUGHING | | | | | | | | | | | | |
| MILL | | | | | | | | | | | | |
| HOT | | 900 | 480 | 2000 | | 480 | 420 | 2000 | | 420 | 5000 | 85 to 217.5 |
| FINISHING | | | | | | | | | | | | |
| MILL | | | | | | | | | | | | |
| PLATE | | 1000 | 535 | 5000 | | 535 | 470 | 5000 | | 470 | 9000 | 95 to 240 |
| MILL | | | | | | | | | | | | |
| SECTION | | 1500 | 800 | 900 | | 800 | 700 | 900 | | 700 | 5000 | 145 to 362.5 |
| MILL | | | | | | | | | | | | |

TABLE 5

| | | | CRITICAL | CRACK LENGTH | THERMAL |
|---|---|---|---|---|---|
| | KIND OF ROLL | | NUMBER OF | ON BARREL | CROWN |
| DIVISION | ROLL CLASSIFICATION | USE | ROLLED STEELS | SURFACE (μm) | (μm) |
| EXAMPLE | CEMENTED CARBIDE | COLD TANDEM MILL | 1000 | 0 | 25 |
| | COMPOSITE ROLL | HOT ROUGHING MILL | 6500 | 0 | 100 |
| | | HOT FINISHING MILL | 3000 (1000) | 0 | 80 |
| | | PLATE MILL | 3000 | 0 | 120 |
| | | SECTION MILL | 800 | 0 | 50 |
| CONVENTIONAL | CEMENTED CARBIDE | COLD TANDEM MILL | 1000 | 0 | 25 |
| EXAMPLE | COMPOSITE ROLL | HOT ROUGHING MILL | 6500 | 0 | 100 |
| | (HAVING CONFIGURATION | HOT FINISHING MILL | 3000 (1000) | 0 | 80 |
| | SHOWN IN FIG. 7) | PLATE MILL | 3000 | 0 | 120 |
| | | SECTION MILL | 800 | 0 | 50 |
| COMPARATIVE | COLD SEMI-HIGH-SPEED | COLD TANDEM MILL | 100 | 50 | 50 |
| EXAMPLE | STEEL | | | | |
| | HOT HIGH-SPEED STEEL | HOT ROUGHING MILL | 800 | 100 | 300 |
| | HOT HIGH-SPEED STEEL | HOT FINISHING MILL | 300 (100) | 100 | 240 |
| | HOT HIGH-SPEED STEEL | PLATE MILL | 300 | 200 | 360 |
| | HOT HIGH-SPEED STEEL | SECTION MILL | 100 | 100 | 100 |

| | ROLLED | YIELD OF CEMENTED | NUMBER OF |
|---|---|---|---|
| | STEEL | CARBIDE IN ROLL | FORMED |
| DIVISION | SHAPE | MANUFACTURE (%) | MEMBERS |
| EXAMPLE | ◯ | 80 | 8 |
| | ◯ | 80 | 10 |
| | ◯ | 80 | 15 |
| | ◯ | 80 | 30 |
| | ◯ | 80 | 5 |
| CONVENTIONAL | ◯ | 20 | 1 |
| EXAMPLE | ◯ | 20 | (INTEGRALLY |
| | ◯ | 20 | FORMED) |
| | ◯ | 20 | |
| | ◯ | 20 | |
| COMPARATIVE | Δ | | |
| EXAMPLE | X | | |
| | X | | |
| | X | | |
| | Δ | | |

CRITICAL NUMBER OF ROLLED STEELS: LIMITS IMPOSED BY WEAR RESISTANCE AND SURFACE DETERIORATION RESISTANCE,
CRACK LENGTH ON DRUM SURFACE: MEASURED BY ULTRASONIC FLAW DETECTION;
THERMAL CROWN: DIFFERENCE Dc (DC − De) BETWEEN THE AMOUNT OF THERMAL EXPANSION Dc OF BARREL CENTER AND THE AMOUNT OF THERMAL EXPANSION De AT 25 mm FROM DRUM END PER DIAMETER;
SHAPE:
◯: SATISFACTORY UNTIL ROLL REPLACEMENT;
Δ: OCCURRENCE OF MEDIUM-DEGREE CENTER STRETCH IN THE FIRST HALF OF ROLLING BEFORE ROLL REPLACEMENT;
X: OCCURRENCE OF SERIOUS CENTER STRETCH IN THE FIRST HALF OF ROLLING BEFORE ROLL REPLACEMENT.
HOT FINISHING MILL: FIGURES OUTSIDE PARENTHESIS FOR #1 STAND; AND FIGURES INSIDE PARENTHESIS FOR #7 STAND.

TABLE 6
ROLL SIZE: OD 560 mm × BARREL LENGTH 1,800 mm × TOTAL LENGTH 3,500 mm

| ITEM | | EXAMPLE 1 | | CONVENTIONAL EXAMPLE | |
|---|---|---|---|---|---|
| DIVISION | | A1 | A2 | A3 | A4 |
| COMPOSITION OF | WC (mass %) | 85 | * | * | * |
| MIXED POWDER OF | Co (mass %) | 15 | * | * | * |
| CEMENTED CARBIDE | | | | | |
| MATERIALS | | | | | |
| ROLL CONFIGURATION | | | | | |
| | | | | 12B | 11B |
| SECTIONAL AREA RATIO S₁/S₂ | | 6.0 | 0.7 | (SINGLE | 0.7 |
| | | | | LAYER) | |
| NUMBER OF FORMED MEMBERS PER ROLL | | 6 | 6 | 2 | 1 |
| | | | | | (INTEGRALLY |
| | | | | | FORMED) |
| CEMENTED CARBIDE | OD (mm) | 560 | 560 | 560 | 560 |
| SLEEVE SIZE | ID (mm) | 335 | 470 | 360 | 470 |
| | LENGTH (mm) | 1800 | 1800 | 1800 | 1800 |
| INNER LAYER | OD (mm) | 335 | 470 | NONE | 470 |
| MEMBER SIZE | ID (mm) | 280 | 280 | | 280 |
| | LENGTH (mm) | 1800 | 1800 | | 1800 |
| INNER LAYER MEMBER MATERIAL | | GRAPHITE | * | | * |
| | | CAST IRON | | | |
| ARBOR | DRUM OD (mm) | 280 | 280 | 360 | 280 |
| | TOTAL LENGTH | 3500 | 3500 | 3800 | 3800 |
| | (mm) | | | | |
| ARBOR MATERIAL | | 5% Cr STEEL | 5% Cr STEEL | 5% Cr STEEL | 5% Cr STEEL |
| SIZE OF (CIP- | OD (mm) | 690 | 690 | 690 | INTEGRALLY |
| TREATED AND | ID (mm) | 300 | 420 | 320 | FORMED |
| MACHINED) FORMED | LENGTH (mm) | 370 | 370 | 1350 | |
| MEMBER | | | | | |
| CIP TREATMENT | PRESSURE (MPa) | 285 | * | * | * |
| | HOLDING TIME | 10 min | * | * | |
| TEMPORARY | TEMP. (° C.) | 750 | * | * | NONE |
| SINTERING | PRESSURE (MPa) | 10⁻¹ to 10⁻² | * | * | |
| | HOLDING TIME | 2 hrs | * | * | |
| | ATMOSPHERE | HYDROGEN | * | * | |
| MAIN SINTERING | TEMP. (° C.) | 1330 | * | * | * |
| AND HID | PRESSURE (MPa) | 100 | * | * | * |
| TREATMENT | HOLDING TIME | 2 hrs | * | * | * |
| | ATMOSPHERE | Ar | * | * | * |
| DIFFUSION WELDING | TEMP. (° C.) | 1250 | * | NONE | * |
| CONDITIONS | PRESSURE (MPa) | 100 | * | | |
| | HOLDING TIME | 2 hrs | * | | |
| | ATMOSPHERE | Ar | * | | |

*: SAME CONDITIONS AS IN EXAMPLE A1

TABLE 7
ROLL SIZE: OD 560 mm × BARREL
LENGTH 1,800 mm × TOTAL LENGTH 3,500 mm

| | | | | CONVENTIONAL | |
|---|---|---|---|---|---|
| ITEM | | EXAMPLE | | EXAMPLE | |
| DIVISION | | A1 | A2 | A3 | A4 |
| RESULT OF | MANUFACTURING | 80 | 80 | 20 | 20 |
| ROLL | YIELD OF | | | | |
| MANUFACTURE | CEMENTED | | | | |
| | CARBIDE (%) | | | | |
| | SLEEVE | NONE | NONE | CRACKED | NONE |
| | CRACKING DURING | | | (IN TWO | |
| | ENGAGEMENT | | | SAMPLES) | |
| | DAYS | 0.5 | 0.5 | 1 day | 3 days |
| | NECESSARY FOR | days | days | | |
| | GRINDING | | | | |

| | | | | |
|---|---|---|---|---|
| ROLLING THROUGHPUT FOR | 10 | 1 | NOT APPLIED | 1 |
| CONVENTIONAL EXAMPLE 4 | | | TO ROLLING | |
| (TIMES) | | | | |

ROLLING THROUGHPUT: ROLLING THROUGHPUT DURING PERIOD OF UP TO DECOMMISSIONING OF ROLLS

TABLE 8
ROLL SIZE: OD 1,500 mm × BARREL LENGTH 900 mm × TOTAL LENGTH 3,800 mm

| | | | | CONVENTIONAL | |
|---|---|---|---|---|---|
| ITEM | | EXAMPLE | | EXAMPLE | |
| DIVISION | | B1 | B2 | B3 | B4 |
| COMPOSITION OF MIXED | WC (mass %) | 85 | * | * | * |
| POWDER OF CEMENTED | Co (mass %) | 15 | * | * | * |
| CARBIDE MATERIALS | | | | | |
| NUMBER OF FORMED MEMBERS PER ROLL | | 5 | 5 | 2 | 1 |
| | | | | | (INTEGRALLY |
| | | | | | FORMED) |
| CEMENTED CARBIDE | OD (mm) | 1500 | * | * | * |
| SLEEVE SIZE | ID (mm) | 730 | 1200 | 730 | 1200 |
| | LENGTH (mm) | 900 | * | * | * |
| INNER LAYER MEMBER | OD (mm) | 730 | 1200 | NONE | 1200 |
| SIZE | ID (mm) | 500 | 500 | | 500 |
| | LENGTH (mm) | 900 | 900 | | 900 |
| INNER LAYER MEMBER MATERIAL | | GRAPHITE CAST | * | | * |
| | | IRON | | | |
| ARBOR | DRUM OD (mm) | 500 | * | 730 | * |
| | TOTAL LENGTH | 3800 | * | * | * |
| | (mm) | | | | |
| ARBOR MATERIAL | | COLD DIE STEEL | * | * | * |
| SIZE OF (CIP-TREATED AND | OD (mm) | 1650 | 1650 | 2000 | INTEGRALLY |
| MACHINED) FORMED MEMBER | ID (mm) | 700 | 1000 | 600 | FORMED |
| | LENGTH (mm) | 265 | * | 800 | |
| CIP TREATMENT | PRESSURE | 285 | * | * | * |
| | (MPa) | | | | |
| | HOLDING TIME | 10 min | * | * | |
| TEMPORARY SINTERING | TEMP. (° C.) | 750 | * | * | NONE |
| | PRESSURE | 10⁻¹ to 10⁻² | * | * | |
| | (MPa) | | | | |
| | HOLDING TIME | 2 hrs | * | * | |
| | ATMOSPHERE | HYDROGEN ATM. | * | * | |
| MAIN SINTERING HIP | TEMP. (° C.) | 1330 | * | * | * |
| TREATMENT | PRESSURE | 100 | * | * | * |
| | (MPa) | | | | |
| | HOLDING TIME | 2 hrs | * | * | * |
| | ATMOSPHERE | Ar | * | * | * |
| DIFFUSION WELDING | TEMP. (° C.) | 1240 | * | NONE | * |
| CONDITIONS | PRESSURE | 100 | * | | |
| | (MPa) | | | | |
| | HOLDING TIME | 1 hrs | * | | |
| | ATMOSPHERE | Ar | * | | |

*: SAME CONDITIONS AS IN EXAMPLE B1

TABLE 9
ROLL SIZE: OD 1,500 mm × BARREL
LENGTH 900 mm × TOTAL LENGTH 3,800 mm

| | | | | CONVENTIONAL | |
|---|---|---|---|---|---|
| ITEM | | EXAMPLE | | EXAMPLE | |
| DIVISION | | B1 | B2 | B3 | B4 |
| RESULT OF | MANUFACTURING | 80 | 80 | 20 | 20 |
| ROLL | YIELD OF | | | | |
| MANUFACTURE | CEMENTED | | | | |
| | CARBIDE (%) | | | | |
| | SLEEVE | NONE | NONE | CRACKED | NONE |
| | CRACKING DURING | | | (IN TWO | |
| | ENGAGEMENT | | | SAMPLES) | |
| | DAYS | 0.5 | 0.5 | 1 day | 3 days |
| | NECESSARY FOR | days | days | | |
| | CUTTING | | | | |

| | | | | |
|---|---|---|---|---|
| ROLLING THROUGHPUT FOR | 10 | 1 | NOT APPLIED | 1 |
| CONVENTIONAL EXAMPLE 4 | | | TO ROLLING | |
| (TIMES) | | | | |

ROLLING THROUGHPUT: ROLLING THROUGHPUT UP TO DECOMMISSIONING OF ROLLS

TABLE 10

| | ROLL SIZE | | |
|---|---|---|---|
| | | BARREL | |
| | DIAMETER | LENGTH | TOTAL LENGTH |
| USE | (mm) | (mm) | (mm) |
| COLD TANDEM MILL | 600 | 1800 | 3500 |
| HOT ROUGHING MILL | 1300 | 2000 | 5000 |
| HOT FINISHING MILL | 900 | 2000 | 5000 |
| PLATE MILL | 1000 | 5000 | 9000 |
| SECTION MILL | 1500 | 900 | 5000 |

TABLE 11

| | PROPERTIES OF MEMBERS OF CEMENTED CARBIDE COMPOSITE ROLL | | | | | | | | | | |
|---|---|---|---|---|---|---|---|---|---|---|---|
| | | | | | | | | | ARBOR | | |
| | CEMENTED CARBIDE SLEEVE | | | | INNER LAYER MEMBER | | | | | CENTER | |
| | MATER- | | | LENGTH | | | | LENGTH | MATER- | DIAMETER | LENGTH |
| USE | IAL | OD (mm) | ID (mm) | (mm) | MATERIAL | OD (mm) | ID (mm) | (mm) | IAL | (mm) | (mm) |
| COLD | WC: 80% | 600 | 320 | 1800 | GRAPHITE | 320 | 280 | 1800 | SKD11 | 280 | 3500 |
| TANDEM | mass | | | | CAST IRON | | | | (JIS | | |
| MILL | Co: 20% | | | | | | | | G4404) | | |
| HOT | mass | 1300 | 700 | 2000 | | 700 | 610 | 2000 | | 610 | 5000 |
| ROUGHING | | | | | | | | | | | |
| MILL | | | | | | | | | | | |
| HOT | | 900 | 480 | 2000 | | 480 | 420 | 2000 | | 420 | 5000 |
| FINISHING | | | | | | | | | | | |
| MILL | | | | | | | | | | | |
| PLATE | | 1000 | 535 | 5000 | | 535 | 470 | 5000 | | 470 | 9000 |
| MILL | | | | | | | | | | | |
| SECTION | | 1500 | 800 | 900 | | 800 | 700 | 900 | | 700 | 5000 |
| MILL | | | | | | | | | | | |

TABLE 12

| | | | | CRACK | | | |
|---|---|---|---|---|---|---|---|
| | | | CRITICAL | LENGTH | | | ROLLING |
| | | | NUMBER | ON | | | THROUGHPUT |
| | KIND OF ROLL | | OF | BARREL | THERMAL | ROLLED | BEFORE DE- |
| | ROLL | | ROLLED | SURFACE | CROWN | STEEL | COMMISSIONING |
| DIVISION | CLASSIFICATION | USE | STEELS | (μm) | (μm) | SHAPE | OF ROLL |
| EXAMPLE | CEMENTED | COLD TANDEM | 1000 | 0 | 25 | ◯ | 10 |
| | CARBIDE | MILL | | | | | |
| | COMPOSITE ROLL | HOT ROUGHING | 6500 | 0 | 100 | ◯ | 5 |
| | | MILL | | | | | |
| | | HOT FINISHING | 3000 | 0 | 80 | ◯ | 6.7 |
| | | MILL | (1000) | | | | |
| | | PLATE MILL | 3000 | 0 | 120 | ◯ | 6.7 |
| | | SECTION MILL | 800 | 0 | 50 | ◯ | 3.3 |
| CONVENTIONAL | CEMENTED | COLD TANDEM | 1000 | 0 | 25 | ◯ | 1 |
| EXAMPLE | CARBIDE | MILL | | | | | |
| | COMPOSITE ROLL | HOT ROUGHING | 6500 | 0 | 100 | ◯ | 1 |
| | | MILL | | | | | |
| | | HOT FINISHING | 3000 | 0 | 80 | ◯ | 1 |
| | | MILL | (1000) | | | | |
| | | PLATE MILL | 3000 | 0 | 120 | ◯ | 1 |
| | | SECTION MILL | 800 | 0 | 50 | ◯ | 1 |
| COMPARATIVE | COLD SEMI- | COLD TANDEM | 100 | 50 | 50 | Δ | |
| EXAMPLE | HIGH-SPEED | MILL | | | | | |
| | STEEL | | | | | | |
| | HOT HIGH-SPEED | HOT ROUGHING | 800 | 100 | 300 | X | |
| | STEEL | MILL | | | | | |
| | HOT HIGH-SPEED | HOT FINISHING | 300 | 100 | 240 | X | |
| | STEEL | MILL | | | | | |
| | HOT HIGH-SPEED | PLATE MILL | 300 | 200 | 360 | X | |
| | STEEL | | | | | | |
| | HOT HIGH-SPEED | SECTION MILL | 100 | 100 | 100 | Δ | |
| | STEEL | | | | | | |

| | YIELD OF | | SECTIONAL |
|---|---|---|---|
| | CEMENTED CARBIDE | NUMBER OF | AREA |
| | IN ROLL | FORMED | RATIO |
| DIVISION | MANUFACTURE (%) | MEMBERS | So/Si |
| EXAMPLE | 80 | 8 | 10.7 |
| | 80 | 10 | 10.2 |
| | 80 | 15 | 10.7 |
| | 80 | 30 | 10.9 |
| | 80 | 5 | 10.7 |
| CONVENTIONAL | 20 | 1 | 0.7 |
| EXAMPLE | 20 | (INTEGRALLY | 0.7 |
| | 20 | FORMED) | 0.7 |
| | 20 | | 0.7 |
| | 20 | | 0.7 |
| COMPARATIVE | | | |
| EXAMPLE | | | |

CRITICAL NUMBER OF ROLLED STEELS: LIMITS IMPOSED BY WEAR RESISTANCE AND SURFACE DETERIORATION RESISTANCE, CRACK LENGTH ON DRUM SURFACE: MEASURED BY ULTRASONIC FLAW DETECTION;
THERMAL CROWN: DIFFERENCE Dc (DC − De) BETWEEN THE AMOUNT OF THERMAL EXPANSION Dc OF BARREL CENTER AND THE AMOUNT OF THERMAL EXPANSION De AT 25 mm FROM DRUM END PER DIAMETER;
SHAPE:
◯: SATISFACTORY UNTIL ROLL REPLACEMENT;
Δ: OCCURRENCE OF MEDIUM-DEGREE CENTER STRETCH IN THE FIRST HALF OF ROLLING BEFORE ROLL REPLACEMENT;
X: OCCURRENCE OF SERIOUS CENTER STRETCH IN THE FIRST HALF OF ROLLING BEFORE ROLL REPLACEMENT.
HOT FINISHING MILL: FIGURES OUTSIDE PARENTHESIS FOR #1 STAND; AND FIGURES INSIDE PARENTHESIS FOR #7 STAND.

TABLE 13

| | | | | | STEEL | | | | |
|---|---|---|---|---|---|---|---|---|---|
| | | | | | SHEET | | | | |
| | ROLL CONDITIONS | | | | SURFACE | ROLL CRACK DEPTH | | | |
| | ROUGHING | | | FINISHING | AFTER | AFTER ROLLING (μm) | | | REMARKS |
| No. | R1 | R2 | R3 | F1 to F7 | ROLLING | R1 | R2 | R3 | EXAMPLE |
| A | CEMENTED | STEEL | STEEL | STEEL | GOOD | 0 | 120 | 50 | EXAMPLE |
| | CARBIDE | | | | | | | | |
| B | STEEL | CEMENTED | STEEL | STEEL | GOOD | 200 | 0 | 30 | EXAMPLE |
| | | CARBIDE | | | | | | | |
| C | STEEL | STEEL | CEMENTED | STEEL | GOOD | 190 | 130 | 0 | EXAMPLE |
| | | | CARBIDE | | | | | | |
| D | CEMENTED | CEMENTED | STEEL | STEEL | GOOD | 0 | 0 | 25 | EXAMPLE |
| | CARBIDE | CARBIDE | | | | | | | |
| E | CEMENTED | STEEL | CEMENTED | STEEL | GOOD | 0 | 115 | 0 | EXAMPLE |
| | CARBIDE | | CARBIDE | | | | | | |
| F | STEEL | CEMENTED | CEMENTED | STEEL | GOOD | 210 | 0 | 0 | EXAMPLE |
| | | CARBIDE | CARBIDE | | | | | | |
| G | CEMENTED | CEMENTED | CEMENTED | STEEL | GOOD | 0. | 0 | 0 | EXAMPLE |
| | CARBIDE | CARBIDE | CARBIDE | | | | | | |
| H | STEEL | STEEL | STEEL | STEEL | SURFACE | 205 | 135 | 60 | COMPARATIVE |
| | | | | | DETERIORATION | | | | EXAMPLE |

TABLE 14

| | | | | | STEEL | | | | |
|---|---|---|---|---|---|---|---|---|---|
| | | | | | SHEET | | | | |
| | ROLL CONDITIONS | | | | SURFACE | ROLL CRACK DEPTH | | | |
| | ROUGHING | | | FINISHING | AFTER | AFTER ROLLING (μm) | | | |
| No. | R1 | R2 | R3 | F1 to F7 | ROLLING | R1 | R2 | R3 | REMARKS |
| I | CEMENTED | CEMENTED | CEMENTED | STEEL | GOOD | 0 | 0 | 0 | EXAMPLE |
| | CARBIDE | CARBIDE | CARBIDE | | | | | | |
| J | STEEL | STEEL | STEEL | STEEL | SURFACE | 50 | 30 | 25 | COMPARATIVE |
| | | | | | DETERIORATION | | | | EXAMPLE |

TABLE 15

| | | | | | | | | | STEEL | ROLL WEAR AFTER | | |
|---|---|---|---|---|---|---|---|---|---|---|---|---|
| | | | | | | | | | SHEET | ROLLING (μm) | | |
| | ROLL CONDITIONS | | | | | | | | SURFACE | (MAX/STAND) | | |
| | ROUGHING | FINISHING | | | | | | | AFTER | CEMENTED | | |
| No. | R1 to R3 | F1 | F2 | F3 | F4 | F5 | F6 | F7 | ROLLING | CARBIDE | STEEL | REMARKS |
| A | STEEL | CE- | STEEL | STEEL | STEEL | STEEL | STEEL | STEEL | GOOD | 2/F1 | 120/F7 | EXAMPLE |
| | | MEN- | | | | | | | | | | |
| | | TED | | | | | | | | | | |
| | | CAR- | | | | | | | | | | |
| | | BIDE | | | | | | | | | | |
| B | STEEL | STEEL | STEEL | STEEL | CE- | STEEL | STEEL | STEEL | GOOD | 2/F4 | 70/F7 | EXAMPLE |
| | | | | | MENTED | | | | | | | |
| | | | | | CARBIDE | | | | | | | |
| C | STEEL | STEEL | STEEL | STEEL | STEEL | STEEL | STEEL | CE- | GOOD | 1/F7 | 140/F6 | EXAMPLE |
| | | | | | | | | MENTED | | | | |
| | | | | | | | | CARBIDE | | | | |
| D | CE- | CE- | CE- | CE- | CE- | CE- | CE- | CE- | GOOD | 3/F2 | — | EXAMPLE |
| | MENTED | MEN- | MEN- | MEN- | MENTED | MEN- | MENTED | MENTED | | | | |
| | CARBIDE | TED | TED | TED | CARBIDE | TED | CARBIDE | CARBIDE | | | | |
| | | CAR- | CAR- | CAR- | | CAR- | | | | | | |
| | | BIDE | BIDE | BIDE | | BIDE | | | | | | |
| E | STEEL | STEEL | STEEL | STEEL | STEEL | STEEL | STEEL | STEEL | SURFACE | — | 160/F7 | COMPAR- |
| | | | | | | | | | DETE- | | | ATIVE |
| | | | | | | | | | RIO- | | | EXAMPLE |
| | | | | | | | | | RATION | | | |

TABLE 16

| | | | | | | | | | STEEL | | | |
|---|---|---|---|---|---|---|---|---|---|---|---|---|
| | | | | | | | | | SHEET | ROLL WEAR AFTER | | |
| | ROLL CONDITIONS | | | | | | | | SURFACE | ROLLING (μm) | | |
| | ROUGHING | FINISHING | | | | | | | AFTER | CEMENTED | | |
| No. | R1 to R3 | F1 | F2 | F3 | F4 | F5 | F6 | F7 | ROLLING | CARBIDE | STEEL | REMARKS |
| F | CE- | CE- | CE- | CE- | CE- | CE- | CE- | CE- | GOOD | ALMOST | — | EXAMPLE |
| | MEN- | MEN- | MEN- | MEN- | MEN- | MEN- | MENTED | MENTED | | NONE | | |
| | TED | TED | TED | TED | TED | TED | CARBIDE | CARBIDE | | | | |
| | CARBIDE | CAR- | CAR- | CAR- | CARBIDE | CAR- | | | | | | |
| | | BIDE | BIDE | BIDE | | BIDE | | | | | | |
| G | STEEL | STEEL | STEEL | STEEL | STEEL | STEEL | STEEL | STEEL | SURFACE | — | 100 to | COMPAR- |
| | | | | | | | | | DETE- | | 160 | ATIVE |
| | | | | | | | | | RIO- | | | EXAMPLE |
| | | | | | | | | | RATION | | | |

What is claimed is:

1. A composite cemented carbide roll having a sleeve comprising a cemented carbide outer layer formed integrally from a plurality of previously sintered cylindrical formed members and an inner layer made of a steel member formed on the inner surface of said outer layer, fixed through engagement with a steel arbor; wherein said sleeve has a length within a range of from 520 to 6,000 mm.

2. A composite cemented carbide roll according to claim 1, wherein the number of said formed members is within a range of from 5 to 30.

3. A composite cemented carbide roll having a sleeve comprising a cemented carbide outer layer formed integrally from a plurality of previously sintered cylindrical formed members and an inner layer made of a steel member formed on the inner surface of said outer layer, fixed through engagement with a steel arbor; wherein said sleeve has a ratio So/Si of the sectional area So of said outer layer in the cross-section perpendicular to the rotation axis to the sectional area Si of said inner layer within a range of from 0.3 to 20.

4. A composite cemented carbide roll according to claim 3, wherein the ratio So/Si of the sectional area So of said outer layer to the sectional area Si of said inner layer is within a range of from 0.8 to 15.

5. A composite cemented carbide roll according to any one of claims 1 to 4, wherein said roll has an outside diameter within a range of from 150 to 800 mm, and is used as a work roll for a cold tandem mill.

6. A composite cemented carbide roll according to any one of claims 1 to 4, wherein said roll has an outside diameter within a range of from 500 to 1,500 mm, and is used as a work roll for a hot roughing mill.

7. A composite cemented carbide roll according to any one of claims 1 to 4, wherein said roll has an outside diameter within a range of from 400 to 1,400 mm, and is used as a work roll for a hot finishing mill.

8. A composite cemented carbide roll according to any one of claims 1 to 4, wherein said roll has an outside diameter within a range of from 500 to 1,500 mm, and is used as a work roll for a plate mill.

9. A composite cemented carbide roll according to any one of claims 1 to 4, wherein said roll has an outside diameter within a range of from 600 to 2,000 mm, and is used as a work roll for a sect ion mill.

10. A hot rolling method of steel, comprising the step of u sing , upon hot rolling steel, rolls hating a cemented carbide surface layer as work rolls for at least a stand of a roughing mill.

11. A hot rolling method of steel, comprising the step of using, upon hot rolling steel, rolls having a cemented carbide surface layer as work rolls for at least a stand of a finishing mill.

12. A hot rolling method of steel according to claim 10 or 11, wherein said roll has a arbor and a sleeve member outside the same, and said sleeve member is formed by integrating a plurality of cemented carbide formed members through connection in the roll axial direction.
